(19) United States
(12) Patent Application Publication
(10) Pub. No.: US 2026/0252809 A1
(43) Pub. Date: Aug. 27, 2026

(54) SYSTEM

(71) Applicant: SoftBank Group Corp., Tokyo (JP)

(72) Inventor: Keyaki ISHIWATARI, Tokyo (JP)

(73) Assignee: SoftBank Group Corp., Tokyo (JP)

(21) Appl. No.: 19/541,419

(22) Filed: Feb. 17, 2026

(30) Foreign Application Priority Data
Feb. 21, 2025 (JP) 2025-027050

(51) Int. Cl. G06F 40/30; G06F 16/9535

(52) U.S. Cl. CPC G06F 40/30; G06F 16/9535

(57) ABSTRACT

The system according to the embodiment comprises a reception unit, a generation unit, and a provision unit. The reception unit is configured to receive instructions from a user. The generation unit is configured to analyze the instructions received by the reception unit and generate an SQL query. The provision unit is configured to extract data based on the SQL query generated by the generation unit and return the result.

### CROSS-REFERENCE TO RELATED APPLICATION

The present application claims priority to and incorporates by reference the entire contents of Japanese Patent Application No. 2025-027050 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, users are required to have knowledge of SQL in order to directly interact with a database, and there has been a problem that data extraction is difficult without specialized knowledge.

### SUMMARY OF THE INVENTION

The system according to the embodiment comprises a reception unit, a generation unit, and a provision unit. The reception unit is configured to receive instructions from a user. The generation unit is configured to analyze the instructions received by the reception unit and generate an SQL query. The provision unit is configured to extract data based on the SQL query generated by the generation unit and return the result.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

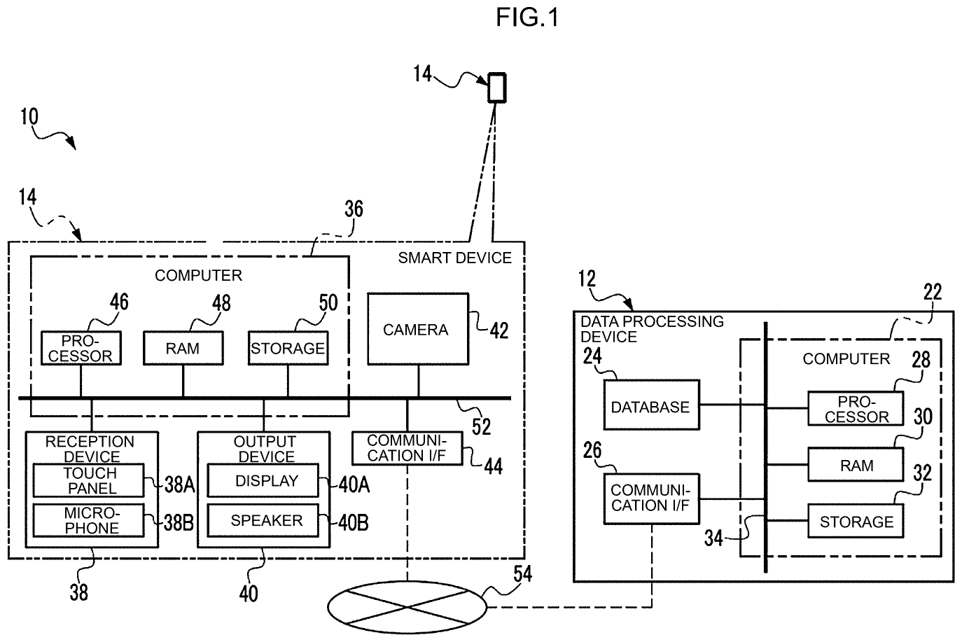

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

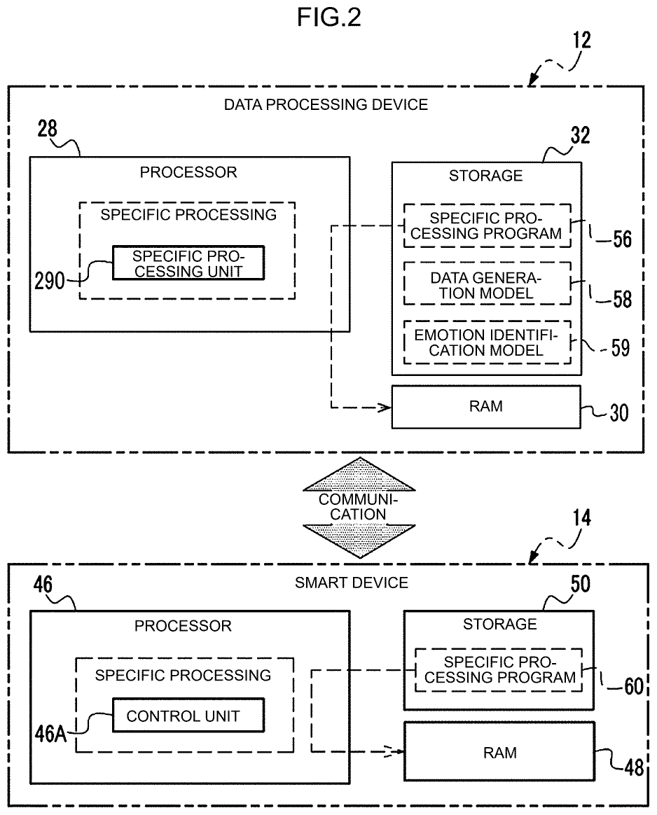

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The database conversation system according to the embodiment of the present invention is a system that enables a user to converse with a database without using SQL. In this system, the user provides necessary data definitions to AI in a chat format, the AI analyzes the instructions and converts them into SQL, executes them in a data warehouse (DWH), and returns the results to the user. For example, when the user instructs, “I want to obtain sales data for 2023,” the AI analyzes the instruction and generates an SQL query such as “SELECT * FROM sales WHERE year=2023.” This SQL query is executed in the DWH, and the sales data for 2023 is extracted. The extracted data is returned to the user, allowing the user to obtain the required data as if directly requesting data extraction from the DWH. With this mechanism, the user can converse with the database without using SQL and easily obtain necessary data simply by entering instructions in a chat format. As a result, database operations become easier and data can be utilized efficiently. Thus, the database conversation system enables the user to converse with the database without using SQL and easily obtain necessary data. Specifically, the database conversation system comprises multiple modules such as a user interface section, a natural language analysis section, an SQL generation section, a database access section, and a response generation section. The system receives instructions from the user in natural language (e.g., “I want to obtain sales data for 2023”) as text data (UTF-8 encoded string, up to about 4096 tokens). Examples of input include “Show me the customer list for 2022” and “Tell me the inventory count for this month.” The natural language analysis section uses a Transformer-based large language model to tokenize the input sentence, perform grammatical analysis (syntax tree generation), semantic analysis (entity extraction, intent estimation), and mapping to SQL structure. For example, entities such as “2023” and “sales data” are extracted from the input sentence and assigned as components of the WHERE clause or SELECT clause. The output of the AI model is an SQL query string (e.g., “SELECT * FROM sales WHERE year=2023”), and examples of output include “SELECT name FROM customers WHERE year=2022” and “SELECT stock FROM inventory WHERE month=‘2023-06’.” The SQL generation section constructs queries based on the extracted entities and conditions in accordance with SQL grammar rules. Furthermore, the SQL generation section obtains database schema information (table names, column names, data types) in advance and performs consistency checks during query generation to reduce the occurrence of syntax errors and runtime errors. The database access section sends the generated SQL query to the data warehouse or relational database and obtains a result set (matrix-form data, e.g., equivalent to a Pandas DataFrame). The response generation section formats the obtained data into an appropriate format such as text, table, or graph image (bar graph, line graph, etc.) based on the user's instructions and past conversation history, and returns it via the user interface section. Internally, the AI model incorporates advanced processing such as fine-tuning using pre-trained weights, custom prompt design for each user, and error correction rules (e.g., SQL injection prevention, automatic escaping of reserved words). With these technical configurations, the system achieves improvements unique to computer technology, such as semantic matching in high-dimensional vector space, rule-based syntax conversion, and high-speed response through parallel distributed processing, which differ from conventional human SQL writing or GUI operations. Technical effects include enabling users without SQL knowledge to extract data with high accuracy and speed, greatly reducing input errors and syntax errors, reducing database operation costs, and shortening overall system response time. Specific application fields include business analysis, automatic generation of sales reports, inventory management, medical data extraction, and learning history analysis in the education field, covering all business scenarios where on-site personnel without SQL knowledge utilize large amounts of data.

The database conversation system according to the embodiment comprises a reception unit, a generation unit, and a provision unit. The reception unit is configured to receive instructions from the user. The user's instructions may include, for example, text input, voice instructions, specific commands, and the like, but are not limited thereto. The reception unit is configured to receive instructions in a text chat format, for example. The reception unit may also receive instructions in a voice chat format. Furthermore, the reception unit may receive instructions in a real-time chat format. For example, the reception unit is configured to receive a user's input of an instruction such as “I want to obtain sales data for 2023” via text chat. The generation unit uses a generation AI to analyze the instructions received by the reception unit and generate an SQL query. The generation unit may use natural language processing technology to analyze the user's instructions and generate an appropriate SQL query. For example, the generation unit analyzes the user's instruction “I want to obtain sales data for 2023” and generates an SQL query such as “SELECT * FROM sales WHERE year=2023.” The generation unit may use a generation AI and keyword extraction technology to extract important information from the user's instructions and generate an SQL query based on that information. For example, the generation unit extracts keywords such as “2023” and “sales data” from the user's instructions and generates an SQL query based on them. The generation unit may use a generation AI and grammatical analysis technology to analyze the user's instructions and generate an SQL query. For example, the generation unit analyzes the grammatical structure of the user's instructions and generates an SQL query based on it. The provision unit extracts data based on the SQL query generated by the generation unit and returns the result to the user. The provision unit extracts data using an appropriate method according to the type of database. For example, when extracting data from a relational database, the provision unit executes the SQL query to extract the data. When extracting data from a NoSQL database, the provision unit may execute an appropriate query to extract the data. The provision unit may filter data based on extraction conditions and extract only the necessary data. For example, the provision unit extracts sales data for 2023 based on the SQL query “SELECT * FROM sales WHERE year=2023.” The provision unit returns the extracted data to the user. For example, the provision unit may return the extracted data to the user in text format. The provision unit may also visually display the extracted data as a graph or chart. Thus, the database conversation system according to the embodiment enables the user to converse with the database without using SQL and easily obtain necessary data. Some or all of the above-described processing in the provision unit may be performed using AI or without using AI. For example, the provision unit may use an AI model that receives the SQL query generated by the generation unit as input, extracts data, and returns a response. Specifically, the database conversation system comprises multiple modules such as a user interface section, a natural language analysis section, an SQL generation section, a database access section, and a response generation section. The reception unit receives instructions from the user in natural language (e.g., “I want to obtain sales data for 2023”) as text data (UTF-8 encoded string, up to about 4096 tokens), voice data (16 kHz PCM, WAV format, up to 30 seconds), or command ID (integer value or JSON structure). Examples of input include “Show me the customer list for 2022” and “Tell me the inventory count for this month.” The natural language analysis section uses a Transformer-based large language model to tokenize the input sentence, perform grammatical analysis (syntax tree generation), semantic analysis (entity extraction, intent estimation), and mapping to SQL structure. For example, entities such as “2023” and “sales data” are extracted from the input sentence and assigned as components of the WHERE clause or SELECT clause. The output of the AI model is an SQL query string (e.g., “SELECT * FROM sales WHERE year=2023”), and examples of output include “SELECT name FROM customers WHERE year=2022” and “SELECT stock FROM inventory WHERE month=‘2023-06’.” The SQL generation section constructs queries based on the extracted entities and conditions in accordance with SQL grammar rules. Furthermore, the SQL generation section obtains database schema information (table names, column names, data types) in advance and performs consistency checks during query generation to reduce the occurrence of syntax errors and runtime errors. The database access section sends the generated SQL query to the data warehouse or relational database and obtains a result set (matrix-form data, e.g., equivalent to a Pandas DataFrame). The response generation section formats the obtained data into an appropriate format such as text, table, or graph image (bar graph, line graph, etc.) based on the user's instructions and past conversation history, and returns it via the user interface section. Internally, the AI model incorporates advanced processing such as fine-tuning using pre-trained weights, custom prompt design for each user, and error correction rules (e.g., SQL injection prevention, automatic escaping of reserved words). With these technical configurations, the system achieves improvements unique to computer technology, such as semantic matching in high-dimensional vector space, rule-based syntax conversion, and high-speed response through parallel distributed processing, which differ from conventional human SQL writing or GUI operations. Technical effects include enabling users without SQL knowledge to extract data with high accuracy and speed, greatly reducing input errors and syntax errors, reducing database operation costs, and shortening overall system response time. Specific application fields include business analysis, automatic generation of sales reports, inventory management, medical data extraction, and learning history analysis in the education field, covering all business scenarios where on-site personnel without SQL knowledge utilize large amounts of data.

The reception unit is configured to receive instructions from the user in a chat format. The reception unit may receive instructions in a text chat format, for example. For example, the reception unit is configured to receive a user's input of an instruction such as “I want to obtain sales data for 2023” via text chat. The reception unit may also receive instructions in a voice chat format. For example, the reception unit is configured to receive a user's input of an instruction such as “I want to obtain sales data for 2023” via voice chat. Furthermore, the reception unit may receive instructions in a real-time chat format. For example, the reception unit is configured to receive a user's input of an instruction such as “I want to obtain sales data for 2023” via real-time chat. Thus, the user can input instructions in a chat format. Specifically, the reception unit is configured to receive instructions from the user as text data (UTF-8 encoded string, up to 4096 tokens), voice data (16 kHz PCM, WAV format, up to 30 seconds), or real-time streaming data. The reception unit may directly transfer the entered text data to the natural language analysis section, or in the case of voice data, convert it to text using a speech recognition module (e.g., RNN-based speech recognition model or Transformer-based encoder-decoder model) and then pass it to the natural language analysis section. In the case of real-time chat, the reception unit uses bidirectional communication protocols such as WebSocket to immediately receive sequential input from the user and perform preprocessing such as buffering and timestamping. Examples of input include “Show me the customer list for 2022” and “Tell me the inventory count for this month,” and examples of voice input include “Show me the latest sales data” and “I want to check the inventory status.” By receiving these diverse input formats through a unified interface, the reception unit improves user experience and automates technical processing such as normalization of input data, noise removal, and timestamp management. Technical effects include the ability to flexibly receive instructions according to the user's usage environment and situation by integrally managing multiple input channels, greatly improving the accessibility and responsiveness of the entire system. In addition, the introduction of speech recognition and real-time communication enhances the ability to handle unstructured data and multimodal input compared to conventional simple text input. Specific application fields include automation of call center operations, hands-free operation for field workers, voice instruction reception in medical settings, and real-time Q&A in the education field, among others. With these configurations, the reception unit not only automates human tasks but also realizes optimization of data flow and efficiency of multimodal input processing unique to computer technology.

The generation unit is configured to analyze the user's instructions and generate an SQL query. The generation unit uses a generation AI to analyze the instructions received by the reception unit and generate an SQL query. The generation unit may use natural language processing technology to analyze the user's instructions and generate an appropriate SQL query. For example, the generation unit analyzes the user's instruction “I want to obtain sales data for 2023” and generates an SQL query such as “SELECT * FROM sales WHERE year=2023.” The generation unit may use a generation AI and keyword extraction technology to extract important information from the user's instructions and generate an SQL query based on that information. For example, the generation unit extracts keywords such as “2023” and “sales data” from the user's instructions and generates an SQL query based on them. The generation unit may use a generation AI and grammatical analysis technology to analyze the user's instructions and generate an SQL query. For example, the generation unit analyzes the grammatical structure of the user's instructions and generates an SQL query based on it. Thus, the generation unit can generate an appropriate SQL query based on the user's instructions. Specifically, the generation unit uses a Transformer-based large language model (e.g., encoder-decoder architecture) to tokenize the text data (natural language sentences up to 4096 tokens) received from the reception unit, perform grammatical analysis (syntax tree generation), semantic analysis (entity extraction, intent estimation), and mapping to SQL structure in stages. Examples of input to the AI include natural language sentences such as “Show me the customer list for 2022” and “Tell me the inventory count for this month,” which are input to the model as token sequences or arrays with grammatical tags. The AI model extracts entities such as “2022,” “customer list,” “this month,” and “inventory count” from the input sentences and assigns them as components of the WHERE clause or SELECT clause. The output of the AI model is an SQL query string (e.g., “SELECT name FROM customers WHERE year=2022” or “SELECT stock FROM inventory WHERE month=‘2023-06’”) and each output value is a syntactically correct SQL statement conforming to the database schema. The generation unit obtains database schema information (table names, column names, data types) in advance during SQL generation and performs consistency checks during query generation to reduce the occurrence of syntax errors and runtime errors. Furthermore, the generation unit incorporates custom prompt design for each user and error correction rules (e.g., SQL injection prevention, automatic escaping of reserved words) to improve security and reliability. The AI model is trained using supervised learning (large datasets of natural language sentences and corresponding SQL query pairs), transfer learning, and fine-tuning, with loss functions such as cross-entropy loss and syntax error rate minimization metrics. Technical effects include resolving semantic ambiguity, semantic matching in high-dimensional vector space, and high-speed response through parallel distributed processing, compared to conventional human SQL writing or rule-based conversion. Specific application fields include business analysis, automatic generation of sales reports, inventory management, medical data extraction, and learning history analysis in the education field, covering all business scenarios where on-site personnel without SQL knowledge utilize large amounts of data. Thus, the generation unit goes beyond mere automation of human tasks and greatly improves the accuracy and efficiency of natural language understanding and structured data generation unique to computer technology.

The provision unit is configured to extract data based on the generated SQL query and return the result to the user. The provision unit extracts data based on the SQL query generated by the generation unit and returns the result to the user. The provision unit extracts data using an appropriate method according to the type of database. For example, when extracting data from a relational database, the provision unit executes the SQL query to extract the data. When extracting data from a NoSQL database, the provision unit may execute an appropriate query to extract the data. The provision unit may filter data based on extraction conditions and extract only the necessary data. For example, the provision unit extracts sales data for 2023 based on the SQL query “SELECT * FROM sales WHERE year=2023.” The provision unit returns the extracted data to the user. For example, the provision unit may return the extracted data to the user in text format. The provision unit may also visually display the extracted data as a graph or chart. Thus, the provision unit can return the extracted data to the user. Specifically, the provision unit transfers the SQL query string received from the generation unit to the database access section and issues appropriate queries to relational databases (e.g., PostgreSQL, MySQL) or NoSQL databases (e.g., document-oriented DB, key-value DB). The database access section obtains matrix-form data (e.g., equivalent to a Pandas DataFrame, with each row as a record and each column as an attribute value) as the query execution result and performs filtering or sorting based on extraction conditions (WHERE clause, LIMIT clause, etc.) as necessary. Examples of extraction include obtaining a list of customer names for 2022 with “SELECT name FROM customers WHERE year=2022” and obtaining the inventory count for June 2023 with “SELECT stock FROM inventory WHERE month=‘2023-06’.” The provision unit passes the obtained data to the response generation section, which formats it into an appropriate format such as text (e.g., “Sales for 2023 is 10 million yen”), table (HTML table or CSV), or graph image (bar graph, line graph, etc.) based on the user's instructions and past conversation history. For graph generation, data visualization libraries (e.g., matplotlib, Plotly) may be used to output image data (PNG, SVG, etc.). Furthermore, the response generation section automatically selects the optimal display format according to the user's terminal environment and past usage history. Technical effects include absorbing differences in database types and output formats, realizing a unified data extraction and response generation flow, improving the flexibility and scalability of the entire system, and enabling quick and accurate responses to diverse user needs. Specific application fields include management dashboards, automatic generation of sales reports, inventory management systems, medical data analysis, and visualization of learning history in the education field. Thus, the provision unit goes beyond mere automation of human tasks and realizes efficiency and reliability improvements in data extraction, visualization, and response generation unique to computer technology.

The reception unit is configured to estimate the user's emotion and adjust the timing of receiving instructions based on the estimated emotion. For example, if the user is feeling stressed, the reception unit temporarily delays receiving instructions and waits until the user relaxes. For example, the reception unit captures the user's facial expression with a camera and estimates the emotion using an emotion estimation algorithm. For example, the reception unit calculates an emotion score based on changes in facial expression and, if it determines that the user is feeling stressed, temporarily delays receiving instructions. If the user is relaxed, the reception unit immediately receives instructions and promptly starts processing. For example, the reception unit records the user's voice and estimates the emotion using voice analysis technology. For example, the reception unit analyzes the tone and speed of the voice and, if it determines that the user is relaxed, immediately receives instructions. If the user is in a hurry, the reception unit preferentially receives instructions and processes them quickly. For example, the reception unit collects the user's biometric data (heart rate and skin conductance) with sensors and estimates the emotion using an emotion estimation algorithm. For example, the reception unit calculates an emotion score based on heart rate fluctuations and, if it determines that the user is in a hurry, preferentially receives instructions. Thus, the timing of receiving instructions can be adjusted according to the user's emotion. Emotion estimation is realized using, for example, an emotion engine or generation AI with emotion estimation functions. The generation AI may be a text generation AI (e.g., LLM) or a multimodal generation AI, but is not limited thereto. Specifically, the reception unit simultaneously acquires multiple input data (image tensor, audio waveform data, biometric sensor values, etc.) to estimate the user's emotional state and inputs them into a multimodal AI model. The AI model receives, for example, a facial image tensor of 128×128 pixels (RGB, 8 bit, 1 frame or time series of 5 frames) as image input, a 16 kHz sampled WAV waveform (up to 30 seconds) as audio input, heart rate (1 Hz sampling, 30 samples), and skin conductance (1 Hz sampling, 30 samples) as biometric data. Examples of input include cases where the user changes facial expressions in front of the camera while saying “I want the data right now” and the heart rate is rising from a wearable sensor. The AI model uses a CNN-based facial expression recognition network for image input, an RNN or Transformer-based speech emotion recognition network for audio input, and a time-series attention model for biometric data to extract features, and finally integrates feature vectors from all modalities to output emotion labels (e.g., stress, relaxation, tension, hurry) and emotion scores (continuous values from 0.0 to 1.0). Examples of output include “Stress: 0.85, Relaxation: 0.10, Hurry: 0.70” or “Relaxation: 0.95, Stress: 0.05.” The reception unit inputs these emotion scores into threshold judgment (e.g., stress>0.8 for temporary delay, hurry>0.6 for immediate reception) or priority assignment logic and dynamically controls the timing of receiving instructions. For example, if stress is high, a 5-second delay timer is activated, and if relaxation is high, instructions are immediately transferred to the natural language analysis section. The AI model is trained using supervised learning with large paired datasets of facial expressions, voice, biometric data, and emotion labels, with loss functions such as cross-entropy loss and regression error. Furthermore, the reception unit can accumulate each user's emotional response patterns and automatically adjust individually optimized thresholds and delay parameters. Technical effects include reducing the user's psychological burden and risk of erroneous operation, greatly improving the quality of user experience, and enhancing the responsiveness and reliability of the entire system. Unlike conventional simple timing control or human operator judgment, the combination of multimodal emotion estimation in high-dimensional feature space and rule-based dynamic control realizes reception optimization unique to computer technology. Specific application fields include call center automatic response systems, reception terminals with stress management in medical settings, Q&A systems with student emotion monitoring in the education field, and hands-free reception terminals for field workers, among others, where timing control of reception according to emotional state is required in various business scenarios.

The reception unit is configured to analyze the user's past instruction history and select an appropriate reception method. For example, the reception unit preferentially proposes instruction methods (voice, text, etc.) that the user has frequently used in the past. For example, the reception unit analyzes the user's past instruction history and preferentially proposes voice instructions to users who frequently use voice instructions. The reception unit may also predict and propose instruction methods used at specific times based on the user's past instruction history. For example, if the user uses text instructions at a specific time, the reception unit preferentially proposes text instructions during that time. The reception unit may also analyze the user's past instruction history and select the most efficient reception method. For example, if the reception unit determines that voice instructions are the most efficient based on the user's past instruction history, it preferentially proposes voice instructions. Thus, the optimal reception method can be selected based on the user's past instruction history. Some or all of the above-described processing in the reception unit may be performed using AI or without using AI. For example, the reception unit may input the user's past instruction history into AI and have the AI select the optimal reception method. Specifically, the reception unit maintains a time-series instruction history database for each user (e.g., a structured table including the reception date and time of each instruction, instruction method (text, voice, command ID, etc.), reception terminal type, reception result, processing time, etc.) and inputs this into the AI model. Examples of input to the AI include user ID “U123,” instruction history for the past 30 days (e.g., 2024-06-01 09:00 text, 2024-06-01 12:00 voice, 2024-06-02 10:00 text . . . ), reception result for each instruction (success/failure), reception terminal (PC, smartphone, etc.), and environmental information at the time of reception (time of day, day of week, location). The AI model uses an RNN or Transformer-based history analysis network specialized for time-series data analysis to extract features (frequency distribution of instruction methods, usage trends by time of day, success rate by terminal, etc.) from the input history. The output of the AI model is structured data such as recommendation scores for each reception method (e.g., text 0.7, voice 0.2, command 0.1) or recommended methods by time of day (e.g., voice in the morning, text in the afternoon). Examples of output include “09:00-12:00: voice instruction recommended, 12:00-18:00: text instruction recommended” or “Overall recommendation: voice 0.65, text 0.30, command 0.05.” The reception unit uses these recommendation scores to preferentially display recommendation buttons on the user interface or automatically select the default reception method. The AI model is trained using supervised learning with each user's history data and actual reception success rate/processing efficiency as teacher signals, and clustering for user type classification. Furthermore, the reception unit can sequentially learn changes in each user's usage trends and update the recommendation logic online. Technical effects include greatly improving reception efficiency and user satisfaction for the entire system by automatically proposing the optimal reception method for each user, thereby reducing the effort and error rate of reception operations. Unlike conventional uniform presentation of reception methods or human operator reference to history, automatic analysis of high-dimensional history data and dynamic recommendation logic realize reception optimization unique to computer technology. Specific application fields include automation of reception in enterprise business systems, optimal reception UI presentation for each doctor/nurse in medical settings, customization of reception methods for each student in the education field, and operator workload reduction in call centers, among others, where reception optimization based on history is required in various business scenarios.

The reception unit is configured to perform filtering at the time of receiving instructions based on the user's current project or field of interest. For example, the reception unit preferentially receives instructions related to the user's ongoing project. For example, the reception unit preferentially receives instructions related to the project name or progress status of the user. The reception unit may also preferentially receive instructions related to the user's field of interest based on the user's past activity history or survey results. The reception unit may also filter out unnecessary instructions based on the user's current project or field of interest. For example, the reception unit filters out instructions unrelated to the user's project or field of interest and does not receive them. Thus, the reception unit can filter instructions based on the user's current project or field of interest. Some or all of the above-described processing in the reception unit may be performed using AI or without using AI. For example, the reception unit may input the user's project or field of interest information into AI and have the AI perform filtering. Specifically, the reception unit maintains structured databases for each user containing current project information (e.g., project ID, name, progress status, start date/end date, related tags, etc.) and field of interest information (e.g., keyword list, survey responses, topic distribution extracted from past instructions, etc.). Examples of input to the AI include user ID “U456,” current project “Business Analysis 2024” (progress 80%, tags: sales, inventory), field of interest “Sales Report,” “Inventory Management,” and the last 30 instructions (natural language sentences or command IDs). The AI model vectorizes the input project/field of interest information and new reception instructions (e.g., “Display the sales trend for 2024 as a graph”) and calculates semantic relevance. The output of the AI model is structured data such as relevance scores for each instruction (e.g., 0.92, 0.15) or reception decision labels (accepted, pending, rejected). Examples of output include “Instruction A: relevance 0.95 (accepted), Instruction B: relevance 0.10 (rejected).” The reception unit inputs these relevance scores into threshold judgment (e.g., accept if 0.7 or higher, reject if less than 0.3) or priority assignment logic and dynamically controls the reception order and filtering. The AI model is trained using supervised learning with past reception results and correspondence with project/field of interest as teacher signals, and clustering in semantic vector space. Furthermore, the reception unit can sequentially learn changes in each user's project progress and field of interest and update the filtering logic online. Technical effects include greatly improving reception efficiency and user satisfaction for the entire system by efficiently receiving only instructions relevant to the user's work situation or interests, thereby greatly reducing unnecessary processing load and erroneous reception. Unlike conventional simple keyword matching or human operator reception judgment, semantic relevance estimation in high-dimensional semantic space and dynamic filtering realize reception optimization unique to computer technology. Specific application fields include automation of reception in project management systems, topic-based reception in R&D settings, optimization of assignment reception for each student in the education field, and case-by-case reception control in sales settings, among others, where reception optimization based on project/field of interest is required in various business scenarios.

The reception unit is configured to estimate the user's emotion and determine the priority of instructions to be received based on the estimated emotion. For example, if the user is feeling stressed, the reception unit postpones instructions of low importance and preferentially receives instructions of high importance. For example, the reception unit captures the user's facial expression with a camera and estimates the emotion using an emotion estimation algorithm. For example, the reception unit calculates an emotion score based on changes in facial expression and, if it determines that the user is feeling stressed, postpones instructions of low importance. If the user is relaxed, the reception unit receives all instructions equally. For example, the reception unit records the user's voice and estimates the emotion using voice analysis technology. For example, the reception unit analyzes the tone and speed of the voice and, if it determines that the user is relaxed, receives all instructions equally. If the user is in a hurry, the reception unit preferentially receives urgent instructions. For example, the reception unit collects the user's biometric data (heart rate and skin conductance) with sensors and estimates the emotion using an emotion estimation algorithm. For example, the reception unit calculates an emotion score based on heart rate fluctuations and, if it determines that the user is in a hurry, preferentially receives urgent instructions. Thus, the priority of instructions to be received can be determined according to the user's emotion. Emotion estimation is realized using, for example, an emotion engine or generation AI with emotion estimation functions. The generation AI may be a text generation AI (e.g., LLM) or a multimodal generation AI, but is not limited thereto. Specifically, the reception unit simultaneously acquires multiple input data (e.g., 128×128 pixel facial image tensor (RGB, 8 bit, 1 frame or time series of 5 frames), 16 kHz sampled WAV audio waveform (up to 30 seconds), heart rate (1 Hz sampling, 30 samples), skin conductance (1 Hz sampling, 30 samples), etc.) to estimate the user's emotional state and inputs them into a multimodal AI model. The AI model uses a CNN-based facial expression recognition network for image input, an RNN or Transformer-based speech emotion recognition network for audio input, and a time-series attention model for biometric data to extract features, integrates feature vectors from all modalities, and outputs emotion labels (e.g., stress, relaxation, hurry) and emotion scores (continuous values from 0.0 to 1.0). Examples of input include cases where the user changes facial expressions in front of the camera while saying “I want the data right now” and the heart rate is rising from a wearable sensor. Examples of AI model output include “Stress: 0.85, Relaxation: 0.10, Hurry: 0.70” or “Relaxation: 0.95, Stress: 0.05.” The reception unit inputs these emotion scores into threshold judgment (e.g., stress>0.8 to postpone low-importance instructions, hurry>0.6 to prioritize urgent instructions) or priority assignment logic and dynamically controls the priority of instructions. For example, if stress is high, low-importance instructions are put on hold for 5 minutes, and if urgency is high, instructions are immediately transferred to the natural language analysis section. The AI model is trained using supervised learning with large paired datasets of facial expressions, voice, biometric data, and emotion labels, with loss functions such as cross-entropy loss and regression error. Furthermore, the reception unit can accumulate each user's emotional response patterns and automatically adjust individually optimized thresholds and priority parameters. Technical effects include reducing the user's psychological burden and risk of erroneous operation, realizing rapid reception of important instructions and delayed reception of unnecessary instructions, and improving the responsiveness and reliability of the entire system. Unlike conventional simple priority control or human operator judgment, the combination of multimodal emotion estimation in high-dimensional feature space and rule-based dynamic priority control realizes reception optimization unique to computer technology. Specific application fields include call center automatic response systems, urgent instruction priority reception terminals in medical settings, assignment reception systems with student emotion monitoring in the education field, and hands-free reception terminals for field workers, among others, where priority control of instructions according to emotional state is required in various business scenarios.

The reception unit is configured to consider the user's geographic location information at the time of receiving instructions and preferentially receive instructions with high relevance. For example, if the user is in a specific region, the reception unit preferentially receives instructions related to that region. For example, the reception unit obtains the user's current location using GPS data or IP address and preferentially receives instructions related to that region. The reception unit may also preferentially receive instructions with high relevance based on the user's current location. For example, the reception unit preferentially receives instructions based on information related to the region where the user is currently located. If the user is moving, the reception unit preferentially receives optimal instructions based on the current location. For example, the reception unit considers the user's movement route and preferentially receives instructions with high relevance. Thus, the reception unit can preferentially receive instructions with high relevance based on the user's geographic location information. Some or all of the above-described processing in the reception unit may be performed using AI or without using AI. For example, the reception unit may input the user's geographic location information into AI and have the AI determine the priority of instructions with high relevance. Specifically, the reception unit obtains geographic location data such as GPS coordinates (latitude and longitude, e.g., 35.6895, 139.6917) acquired from the user's terminal, region information estimated from IP address (prefecture/city level), and Wi-Fi access point information (BSSID list) as structured data. Examples of input to the AI include user ID “U789,” current location “Chiyoda-ku, Tokyo,” movement route (GPS track for the past 30 minutes), current time, and past reception instructions (e.g., “Check inventory at nearby stores,” “Get local event information”). The AI model vectorizes the geographic location information and reception instruction content and calculates a region relevance score (0.0 to 1.0). The output of the AI model is a region relevance score and priority label (e.g., high, medium, low) for each instruction, and examples of output include “Instruction A: relevance 0.95 (priority), Instruction B: relevance 0.20 (postponed).” The reception unit inputs these scores into threshold judgment (e.g., priority reception if 0.7 or higher) or priority assignment logic and dynamically controls the reception order. If the user is moving, the relevance between region information along the movement route and instruction content is evaluated in time series, and instructions are received at the optimal timing. The AI model is trained using supervised learning with past reception results and correspondence with region information as teacher signals, and geographic clustering. Furthermore, the reception unit can sequentially learn each user's movement patterns and usage trends by region and update the priority logic online. Technical effects include greatly improving reception efficiency and user satisfaction for the entire system by efficiently receiving only instructions relevant to the user's current location or movement status, thereby greatly reducing unnecessary processing load and erroneous reception. Unlike conventional simple keyword matching or human operator region judgment, region relevance estimation in high-dimensional geographic space and dynamic priority control realize reception optimization unique to computer technology. Specific application fields include local event guidance systems, region-based reception control in logistics settings, area-based case reception in sales settings, and tourist information terminals, among others, where reception optimization based on geographic location information is required in various business scenarios.

The reception unit is configured to analyze the user's social media activity at the time of receiving instructions and receive relevant instructions. For example, the reception unit preferentially receives instructions based on content mentioned by the user on social media. For example, the reception unit analyzes the user's social media posts and preferentially receives relevant instructions. The reception unit may also preferentially receive instructions related to fields of high interest based on the user's social media activity. For example, the reception unit analyzes the user's social media activity history and preferentially receives instructions related to fields of high interest. The reception unit may also analyze the user's social media activity and preferentially receive the most relevant instructions. For example, the reception unit preferentially receives instructions with high relevance based on social media trends and follower count. Thus, the reception unit can receive relevant instructions based on the user's social media activity. Some or all of the above-described processing in the reception unit may be performed using AI or without using AI. For example, the reception unit may input the user's social media activity data into AI and have the AI receive relevant instructions. Specifically, the reception unit obtains the user's social media activity data (e.g., the latest 100 post texts, post date and time, number of likes, number of retweets, number of followers, frequency of trending words, etc.) as a structured database and inputs it into the AI model. Examples of input to the AI include user ID “U234,” post content for the past 30 days (natural language sentences), engagement metrics for each post (e.g., 50 likes, 10 retweets), trending word list (e.g., “AI,” “inventory management,” “sales analysis”). The AI model vectorizes the post content using a natural language processing model (e.g., Transformer-based text classification network), performs interest field clustering and topic extraction, and calculates semantic relevance between instruction content and post content, outputting relevance scores (0.0 to 1.0) and priority labels (high, medium, low). Examples of output include “Instruction A: relevance 0.90 (priority), Instruction B: relevance 0.15 (postponed)” or “Sales analysis-related instruction: high priority.” The reception unit inputs these scores into threshold judgment (e.g., priority reception if 0.7 or higher) or priority assignment logic and dynamically controls the reception order. The AI model is trained using supervised learning with past reception results and correspondence with social media activity as teacher signals, and topic distribution clustering. Furthermore, the reception unit can sequentially learn each user's field of interest and trend changes and update the priority logic online. Technical effects include greatly improving reception efficiency and user satisfaction for the entire system by efficiently receiving only instructions relevant to the user's latest interests and social trends, thereby greatly reducing unnecessary processing load and erroneous reception. Unlike conventional simple keyword matching or human operator trend judgment, semantic relevance estimation in high-dimensional semantic space and dynamic priority control realize reception optimization unique to computer technology. Specific application fields include marketing analysis support systems, trend-linked reception in sales settings, assignment reception by field of interest in the education field, and topic-linked reception in customer support, among others, where reception optimization based on social media activity is required in various business scenarios.

The generation unit is configured to estimate the user's emotion and adjust the method of generating SQL queries based on the estimated emotion. For example, if the user is relaxed, the generation unit generates detailed SQL queries. For example, the generation unit captures the user's facial expression with a camera and estimates the emotion using an emotion estimation algorithm. For example, the generation unit calculates an emotion score based on changes in facial expression and, if it determines that the user is relaxed, generates detailed SQL queries. If the user is in a hurry, the generation unit generates concise SQL queries. For example, the generation unit records the user's voice and estimates the emotion using voice analysis technology. For example, the generation unit analyzes the tone and speed of the voice and, if it determines that the user is in a hurry, generates concise SQL queries. If the user is feeling stressed, the generation unit generates SQL queries with fewer errors. For example, the generation unit collects the user's biometric data (heart rate and skin conductance) with sensors and estimates the emotion using an emotion estimation algorithm. For example, the generation unit calculates an emotion score based on heart rate fluctuations and, if it determines that the user is feeling stressed, generates SQL queries with fewer errors. Thus, the method of generating SQL queries can be adjusted according to the user's emotion. Emotion estimation is realized using, for example, an emotion engine or generation AI with emotion estimation functions. The generation AI may be a text generation AI (e.g., LLM) or a multimodal generation AI, but is not limited thereto. Specifically, the generation unit simultaneously acquires multiple input data (e.g., 128×128 pixel facial image tensor (RGB, 8 bit, 1 frame or time series of 5 frames), 16 kHz sampled WAV audio waveform (up to 30 seconds), heart rate (1 Hz sampling, 30 samples), skin conductance (1 Hz sampling, 30 samples), etc.) to estimate the user's emotional state and inputs them into a multimodal AI model. The AI model uses a CNN-based facial expression recognition network for image input, an RNN or Transformer-based speech emotion recognition network for audio input, and a time-series attention model for biometric data to extract features, integrates feature vectors from all modalities, and outputs emotion labels (e.g., stress, relaxation, hurry) and emotion scores (continuous values from 0.0 to 1.0). Examples of input to the AI include cases where the user changes facial expressions in front of the camera while saying “I want the data right now” and the heart rate is rising from a wearable sensor. Examples of AI model output include “Stress: 0.85, Relaxation: 0.10, Hurry: 0.70” or “Relaxation: 0.95, Stress: 0.05.” The generation unit inputs these emotion scores into threshold judgment (e.g., stress>0.8 for error reduction, relaxation>0.8 for detail, hurry>0.6 for conciseness) or generation parameter control logic and dynamically adjusts the method of generating SQL queries (number of items in SELECT clause, number of conditions in WHERE clause, presence of JOIN clause, setting of LIMIT clause, etc.). For example, in a relaxed state, the generation unit generates SQL queries including detailed aggregation and multi-condition filters; in a hurry state, the generation unit generates SQL queries extracting only the minimum necessary columns; in a stress state, the generation unit generates safe SQL queries based on templates to minimize the risk of syntax errors and execution errors. The AI model is trained using supervised learning with large paired datasets of facial expressions, voice, biometric data, and emotion labels, with loss functions such as cross-entropy loss and regression error. Furthermore, the generation unit can accumulate each user's emotional response patterns and past query generation history and automatically adjust individually optimized generation parameters. Technical effects include enabling SQL query generation according to the user's psychological state and usage situation, reducing erroneous operations and error rates, improving the quality of user experience, and enhancing the responsiveness and reliability of the entire system. Unlike conventional uniform query generation or manual adjustment by human operators, the combination of multimodal emotion estimation in high-dimensional feature space and rule-based dynamic generation control realizes query generation optimization unique to computer technology. Specific application fields include call center automatic response systems, data extraction with stress management in medical settings, learning history analysis with student emotion monitoring in the education field, and hands-free reception terminals for field workers, among others, where query generation control according to emotional state is required in various business scenarios.

The generation unit is configured to adjust the level of detail of generation based on the importance of the instructions when generating SQL queries. For example, for instructions of high importance, the generation unit generates detailed SQL queries. For example, the generation unit evaluates the importance of the user's instructions and generates detailed SQL queries for instructions of high importance. For instructions of low importance, the generation unit generates concise SQL queries. For example, the generation unit evaluates the importance of the user's instructions and generates concise SQL queries for instructions of low importance. The generation unit dynamically adjusts the level of detail of SQL queries according to the importance of the instructions. For example, the generation unit evaluates the importance of the user's instructions and dynamically adjusts the level of detail of SQL queries according to the importance. Thus, the level of detail of SQL queries can be adjusted according to the importance of the instructions. Some or all of the above-described processing in the generation unit may be performed using AI or without using AI. For example, the generation unit may input the importance of the user's instructions into AI and have the AI adjust the level of detail of SQL queries. Specifically, the generation unit calculates an importance score (e.g., continuous value from 0.0 to 1.0 or label of low, medium, high) for each instruction received from the user and dynamically controls SQL query generation parameters (number of columns in SELECT clause, number of conditions in WHERE clause, presence of GROUP BY or ORDER BY, complexity of JOIN clause, setting of LIMIT clause, etc.) based on this score. Examples of input to the AI include “I want to obtain sales data for 2023 (importance: high),” “Tell me the inventory count for this month (importance: medium),” “Check yesterday's login history (importance: low).” The AI model inputs features such as instruction content, past usage history, business rules, and user attributes, and outputs importance scores using an importance estimation network (e.g., Transformer-based classification or regression model). Examples of AI model output include “Instruction A: importance 0.95,” “Instruction B: importance 0.40.” For high importance, the generation unit generates SQL queries including detailed aggregation and multi-condition filters; for low importance, the generation unit generates concise SQL queries extracting only the minimum necessary columns. Furthermore, the generation unit can dynamically adjust query execution priority and resource allocation according to importance. The AI model is trained using supervised learning with past instructions and business deliverables as datasets, and reinforcement learning using user feedback. Technical effects include enabling SQL query generation according to business importance and urgency, optimizing system resources, shortening response time, reducing erroneous operation risk, and improving user satisfaction. Unlike conventional uniform query generation or manual adjustment by human operators, the combination of importance estimation in high-dimensional feature space and dynamic generation control realizes query generation optimization unique to computer technology. Specific application fields include extraction of important indicators in management analysis dashboards, urgent data extraction in medical settings, report generation by case priority in sales settings, and data extraction by assignment importance in the education field, among others, where query generation control according to importance is required in various business scenarios.

The generation unit is configured to apply different generation algorithms according to the category of instructions when generating SQL queries. For example, for instructions related to sales data, the generation unit applies a dedicated generation algorithm for sales data. For example, when the generation unit receives instructions related to sales data, it applies a dedicated generation algorithm for sales data to generate SQL queries. For instructions related to customer data, the generation unit applies a dedicated generation algorithm for customer data. For example, when the generation unit receives instructions related to customer data, it applies a dedicated generation algorithm for customer data to generate SQL queries. For instructions related to inventory data, the generation unit applies a dedicated generation algorithm for inventory data. For example, when the generation unit receives instructions related to inventory data, it applies a dedicated generation algorithm for inventory data to generate SQL queries. Thus, the generation unit can apply appropriate generation algorithms according to the category of instructions. Some or all of the above-described processing in the generation unit may be performed using AI or without using AI. For example, the generation unit may input the category of instructions into AI and have the AI apply the appropriate generation algorithm. Specifically, the generation unit tokenizes and parses the instruction sentences received from the user in the natural language analysis section, and automatically determines the instruction category (e.g., sales, customer, inventory, purchasing, expenses, etc.) using a classification network (e.g., Transformer-based text classification model). Examples of input to the AI include “I want to obtain sales data for 2023,” “Tell me the inventory count for this month,” “Show me the customer list for 2022.” The AI model outputs category labels (e.g., sales, inventory, customer) and category-specific confidence scores (e.g., sales 0.95, inventory 0.03, customer 0.02). Examples of output include “Instruction A: sales category,” “Instruction B: inventory category.” The generation unit selects and applies a dedicated SQL template generation algorithm for each category according to the category determination result, such as a sales table JOIN, period aggregation, department-based GROUP BY for sales data; customer attribute filtering, history JOIN for customer data; inventory table JOIN, extraction of latest inventory count for inventory data, and generates SQL queries. Furthermore, the generation unit automatically applies different schema information and business rules for each category (e.g., monthly aggregation for sales, daily update for inventory) to reduce syntax errors and business logic inconsistencies. The AI model is trained using supervised learning with large paired datasets of category-labeled instruction sentences and corresponding SQL queries, and automatic template generation for each category. Technical effects include greatly improving the accuracy, efficiency, and maintainability of SQL query generation optimized for instruction content, and reducing the risk of erroneous generation and deviation from business logic. Unlike conventional uniform query generation or manual category selection by human operators, the combination of category classification in high-dimensional semantic space and dynamic algorithm selection realizes query generation optimization unique to computer technology. Specific application fields include extraction of indicator-specific data in management analysis dashboards, extraction of patient, test, and medication category data in medical settings, report generation by case, customer, and sales category in sales settings, and extraction of grade, attendance, and assignment category data in the education field, among others, where query generation control according to category is required in various business scenarios.

The generation unit is configured to estimate the user's emotion and adjust the length of the SQL query based on the estimated emotion. For example, if the user is in a hurry, the generation unit generates a short SQL query that covers the main points. For example, the generation unit captures the user's facial expression with a camera and estimates the emotion using an emotion estimation algorithm. For example, the generation unit calculates an emotion score based on changes in facial expression and, if it determines that the user is in a hurry, generates a short SQL query that covers the main points. If the user is relaxed, the generation unit generates a longer SQL query with detailed explanations. For example, the generation unit records the user's voice and estimates the emotion using voice analysis technology. For example, the generation unit analyzes the tone and speed of the voice and, if it determines that the user is relaxed, generates a longer SQL query with detailed explanations. If the user is feeling stressed, the generation unit generates a short SQL query with fewer errors. For example, the generation unit collects the user's biometric data (heart rate and skin conductance) with sensors and estimates the emotion using an emotion estimation algorithm. For example, the generation unit calculates an emotion score based on heart rate fluctuations and, if it determines that the user is feeling stressed, generates a short SQL query with fewer errors. Thus, the length of the SQL query can be adjusted according to the user's emotion. Emotion estimation is realized using, for example, an emotion engine or generation AI with emotion estimation functions. The generation AI may be a text generation AI (e.g., LLM) or a multimodal generation AI, but is not limited thereto. Specifically, the generation unit simultaneously acquires multiple input data (e.g., 128×128 pixel facial image tensor (RGB, 8 bit, 1 frame or time series of 5 frames), 16 kHz sampled WAV audio waveform (up to 30 seconds), heart rate (1 Hz sampling, 30 samples), skin conductance (1 Hz sampling, 30 samples), etc.) to estimate the user's emotional state and inputs them into a multimodal AI model. The AI model uses a CNN-based facial expression recognition network for image input, an RNN or Transformer-based speech emotion recognition network for audio input, and a time-series attention model for biometric data to extract features, integrates feature vectors from all modalities, and outputs emotion labels (e.g., stress, relaxation, hurry) and emotion scores (continuous values from 0.0 to 1.0). Examples of input to the AI include cases where the user changes facial expressions in front of the camera while saying “I want the data right now” and the heart rate is rising from a wearable sensor. Examples of AI model output include “Stress: 0.85, Relaxation: 0.10, Hurry: 0.70” or “Relaxation: 0.95, Stress: 0.05.” The generation unit inputs these emotion scores into threshold judgment (e.g., hurry>0.6 for shortening, relaxation>0.8 for detail, stress>0.8 for error reduction) or generation parameter control logic and dynamically adjusts the length of the SQL query (number of items in SELECT clause, number of conditions in WHERE clause, presence of JOIN clause, setting of LIMIT clause, etc.). For example, in a hurry state, the generation unit generates a minimal query such as SELECT * FROM sales WHERE year=2023; in a relaxed state, the generation unit generates a detailed query such as SELECT sales.id, sales.amount, sales.region, sales.date, customers.name FROM sales JOIN customers ON sales.customer_id=customers.id WHERE sales.year=2023; in a stress state, the generation unit generates a safe, short query based on templates. The AI model is trained using supervised learning with large paired datasets of facial expressions, voice, biometric data, and emotion labels, with loss functions such as cross-entropy loss and regression error. Furthermore, the generation unit can accumulate each user's emotional response patterns and past query generation history and automatically adjust individually optimized generation parameters. Technical effects include enabling control of SQL query length according to the user's psychological state and usage situation, reducing erroneous operations and error rates, improving the quality of user experience, and enhancing the responsiveness and reliability of the entire system. Unlike conventional uniform query length or manual adjustment by human operators, the combination of multimodal emotion estimation in high-dimensional feature space and rule-based dynamic length control realizes query generation optimization unique to computer technology. Specific application fields include call center automatic response systems, data extraction with stress management in medical settings, learning history analysis with student emotion monitoring in the education field, and hands-free reception terminals for field workers, among others, where query length control according to emotional state is required in various business scenarios.

The generation unit is configured to determine the priority of generation based on the submission timing of the instructions when generating SQL queries. For example, for instructions submitted earlier, the generation unit preferentially generates SQL queries. For example, the generation unit evaluates the submission timing of the user's instructions and preferentially generates SQL queries for instructions submitted earlier. For instructions submitted later, the generation unit generates SQL queries after postponing them. For example, the generation unit evaluates the submission timing of the user's instructions and generates SQL queries after postponing instructions submitted later. The generation unit dynamically adjusts the priority of SQL query generation according to the submission timing of the instructions. For example, the generation unit evaluates the submission timing of the user's instructions and dynamically adjusts the priority of SQL query generation according to the submission timing. Thus, the priority of SQL query generation can be determined according to the submission timing of the instructions. Some or all of the above-described processing in the generation unit may be performed using AI or without using AI. For example, the generation unit may input the submission timing of the user's instructions into AI and have the AI determine the priority of SQL query generation. Specifically, the generation unit records the submission time (timestamp, e.g., 2024-06-01 09:00:00) for each instruction received from the reception unit and manages the instruction queue in chronological order. Examples of input to the AI include instruction A (2024-06-01 09:00), instruction B (2024-06-01 09:05), instruction C (2024-06-01 09:10). The AI model inputs features such as submission timing, instruction content, user attributes, and past processing history, and outputs generation priority scores (0.0 to 1.0) for each instruction using a priority estimation network (e.g., time-series RNN or Transformer-based priority estimation model). Examples of AI model output include “Instruction A: priority 0.95,” “Instruction B: priority 0.80,” “Instruction C: priority 0.60.” The generation unit dynamically adjusts the order of SQL query generation and resource allocation based on the priority scores. Furthermore, the generation unit can perform complex priority control considering not only submission timing but also importance, relevance, and user urgency flags. The AI model is trained using supervised learning with past instruction submission times and actual processing priority/business deliverables as datasets, and reinforcement learning using user feedback. Technical effects include enabling SQL query generation according to instruction submission order and business urgency, improving system responsiveness, fairness, and user satisfaction, and reducing erroneous operation and delay risks. Unlike conventional simple FIFO processing or manual priority adjustment by human operators, the combination of time-series priority estimation in high-dimensional feature space and dynamic generation control realizes query generation optimization unique to computer technology. Specific application fields include reception order control in call center automatic response systems, priority processing of urgent instructions in medical settings, case submission order control in sales settings, and assignment submission order control in the education field, among others, where query generation control according to submission timing is required in various business scenarios.

The generation unit is configured to adjust the order of generation based on the relevance of the instructions when generating SQL queries. For example, for instructions with high relevance, the generation unit preferentially generates SQL queries. For example, the generation unit evaluates the relevance of the user's instructions and preferentially generates SQL queries for instructions with high relevance. For instructions with low relevance, the generation unit generates SQL queries after postponing them. For example, the generation unit evaluates the relevance of the user's instructions and generates SQL queries after postponing instructions with low relevance. The generation unit dynamically adjusts the order of SQL query generation according to the relevance of the instructions. For example, the generation unit evaluates the relevance of the user's instructions and dynamically adjusts the order of SQL query generation according to the relevance. Thus, the order of SQL query generation can be adjusted according to the relevance of the instructions. Some or all of the above-described processing in the generation unit may be performed using AI or without using AI. For example, the generation unit may input the relevance of the user's instructions into AI and have the AI adjust the order of SQL query generation. Specifically, the generation unit tokenizes and parses multiple instruction sentences received from the reception unit in the natural language analysis section and calculates semantic relevance between instructions (e.g., cosine similarity, semantic vector distance, topic match rate, etc.). Examples of input to the AI include “I want to obtain sales data for 2023,” “Tell me the inventory count for 2023,” “Show me the customer list for 2022.” The AI model inputs features such as instruction content, past usage history, business rules, and user attributes, and outputs relevance scores (0.0 to 1.0) for each instruction using a relevance estimation network (e.g., Transformer-based semantic vector generation model). Examples of AI model output include “Instruction A-B: relevance 0.95,” “Instruction A-C: relevance 0.40.” The generation unit groups instructions with high relevance and generates and executes SQL queries in the same batch to improve database access efficiency and cache hit rate. Instructions with low relevance are postponed to achieve optimal resource allocation. Furthermore, the generation unit can dynamically adjust query execution priority and resource allocation according to relevance. The AI model is trained using supervised learning with past instruction pairs and business deliverables as datasets, and clustering in semantic vector space. Technical effects include enabling SQL query generation according to business relevance and data dependency, optimizing system resources, shortening response time, reducing erroneous operation risk, and improving user satisfaction. Unlike conventional uniform query generation or manual relevance adjustment by human operators, the combination of relevance estimation in high-dimensional semantic space and dynamic generation order control realizes query generation optimization unique to computer technology. Specific application fields include utilization of indicator relevance in management analysis dashboards, extraction of related patient, test, and medication data in medical settings, report generation by case, customer, and sales relevance in sales settings, and extraction of grade, attendance, and assignment related data in the education field, among others, where query generation control according to relevance is required in various business scenarios.

The provision unit is configured to estimate the user's emotion and adjust the method of providing data based on the estimated emotion. For example, if the user is relaxed, the provision unit provides detailed data. For example, the provision unit captures the user's facial expression with a camera and estimates the emotion using an emotion estimation algorithm. For example, the provision unit calculates an emotion score based on changes in facial expression and, if it determines that the user is relaxed, provides detailed data. If the user is in a hurry, the provision unit provides concise data. For example, the provision unit records the user's voice and estimates the emotion using voice analysis technology. For example, the provision unit analyzes the tone and speed of the voice and, if it determines that the user is in a hurry, provides concise data. If the user is feeling stressed, the provision unit provides data with fewer errors. For example, the provision unit collects the user's biometric data (heart rate and skin conductance) with sensors and estimates the emotion using an emotion estimation algorithm. For example, the provision unit calculates an emotion score based on heart rate fluctuations and, if it determines that the user is feeling stressed, provides data with fewer errors. Thus, the method of providing data can be adjusted according to the user's emotion. Emotion estimation is realized using, for example, an emotion engine or generation AI with emotion estimation functions. The generation AI may be a text generation AI (e.g., LLM) or a multimodal generation AI, but is not limited thereto. Specifically, the provision unit simultaneously acquires multiple input data (e.g., 128×128 pixel facial image tensor (RGB, 8 bit, 1 frame or time series of 5 frames), 16 kHz sampled WAV audio waveform (up to 30 seconds), heart rate (1 Hz sampling, 30 samples), skin conductance (1 Hz sampling, 30 samples), etc.) to estimate the user's emotional state and inputs them into a multimodal AI model. The AI model uses a CNN-based facial expression recognition network for image input, an RNN or Transformer-based speech emotion recognition network for audio input, and a time-series attention model for biometric data to extract features, integrates feature vectors from all modalities, and outputs emotion labels (e.g., stress, relaxation, hurry) and emotion scores (continuous values from 0.0 to 1.0). Examples of input to the AI include cases where the user changes facial expressions in front of the camera while saying “I want the data right now” and the heart rate is rising from a wearable sensor. Examples of AI model output include “Stress: 0.85, Relaxation: 0.10, Hurry: 0.70” or “Relaxation: 0.95, Stress: 0.05.” The provision unit inputs these emotion scores into threshold judgment (e.g., stress>0.8 for error reduction, relaxation>0.8 for detail, hurry>0.6 for conciseness) or provision parameter control logic and dynamically adjusts the method of providing data (number of columns in tables, level of detail in graphs, presence of explanatory text, limitation of number of data items, etc.). For example, in a relaxed state, the provision unit provides data including detailed aggregation and multi-item graphs; in a hurry state, the provision unit returns only the minimum necessary summary data; in a stress state, the provision unit provides only safe data based on templates to minimize the risk of syntax errors and execution errors. The AI model is trained using supervised learning with large paired datasets of facial expressions, voice, biometric data, and emotion labels, with loss functions such as cross-entropy loss and regression error. Furthermore, the provision unit can accumulate each user's emotional response patterns and past data provision history and automatically adjust individually optimized provision parameters. Technical effects include enabling data provision according to the user's psychological state and usage situation, reducing erroneous operations and error rates, improving the quality of user experience, and enhancing the responsiveness and reliability of the entire system. Unlike conventional uniform data provision or manual adjustment by human operators, the combination of multimodal emotion estimation in high-dimensional feature space and rule-based dynamic provision control realizes data provision optimization unique to computer technology. Specific application fields include call center automatic response systems, data provision with stress management in medical settings, learning history analysis with student emotion monitoring in the education field, and hands-free reception terminals for field workers, among others, where data provision control according to emotional state is required in various business scenarios.

The provision unit is configured to analyze the user's past data usage history at the time of providing data and select an appropriate provision method. For example, the provision unit preferentially proposes data provision methods that the user has frequently used in the past. For example, the provision unit analyzes the user's past data usage history and preferentially proposes frequently used data provision methods. The provision unit may also predict and propose data provision methods used at specific times based on the user's past data usage history. For example, if the user uses a specific data provision method at a specific time, the provision unit preferentially proposes that data provision method during that time. The provision unit may also analyze the user's past data usage history and select the most efficient data provision method. For example, the provision unit analyzes the user's past data usage history and selects the most efficient data provision method. Thus, the optimal provision method can be selected based on the user's past data usage history. Some or all of the above-described processing in the provision unit may be performed using AI or without using AI. For example, the provision unit may input the user's past data usage history into AI and have the AI select the optimal provision method. Specifically, the provision unit maintains a time-series data usage history database for each user (e.g., a structured table including the reception date and time of each data provision request, provision method (text, table, graph, image, etc.), terminal type, usage result, processing time, etc.) and inputs this into the AI model. Examples of input to the AI include user ID “U123,” data usage history for the past 30 days (e.g., 2024-06-01 09:00 text, 2024-06-01 12:00 graph, 2024-06-02 10:00 table . . . ), usage result for each provision method (satisfaction, dissatisfaction, re-request), terminal (PC, smartphone, etc.), and environmental information at the time of use (time of day, day of week, location). The AI model uses an RNN or Transformer-based history analysis network specialized for time-series data analysis to extract features (frequency distribution of provision methods, usage trends by time of day, satisfaction by terminal, etc.) from the input history. The output of the AI model is structured data such as recommendation scores for each provision method (e.g., text 0.7, graph 0.2, table 0.1) or recommended methods by time of day (e.g., graph in the morning, text in the afternoon). Examples of output include “09:00-12:00: graph recommended, 12:00-18:00: text recommended” or “Overall recommendation: graph 0.65, text 0.30, table 0.05.” The provision unit uses these recommendation scores to preferentially display recommendation buttons on the user interface or automatically select the default provision method. The AI model is trained using supervised learning with each user's history data and actual usage satisfaction/processing efficiency as teacher signals, and clustering for user type classification. Furthermore, the provision unit can sequentially learn changes in each user's usage trends and update the recommendation logic online. Technical effects include greatly improving provision efficiency and user satisfaction for the entire system by automatically proposing the optimal data provision method for each user, thereby reducing the effort and error rate of provision operations. Unlike conventional uniform presentation of provision methods or human operator reference to history, automatic analysis of high-dimensional history data and dynamic recommendation logic realize data provision optimization unique to computer technology. Specific application fields include automation of data provision in enterprise business systems, optimal provision UI presentation for each doctor/nurse in medical settings, customization of data provision methods for each student in the education field, and data provision linked to usage history in customer support, among others, where data provision optimization based on history is required in various business scenarios.

The provision unit can customize the means of provision based on the user's current living situation when providing data. For example, the provision unit provides concise data when the user is busy. Specifically, the provision unit evaluates the user's living situation, and if it determines that the user is busy, it provides concise data. Conversely, when the user is relaxed, the provision unit provides detailed data. For example, the provision unit evaluates the user's living situation, and if it determines that the user is relaxed, it provides detailed data. Furthermore, the provision unit dynamically customizes the means of data provision according to the user's living situation. For example, the provision unit evaluates the user's living situation and dynamically customizes the means of data provision according to the living situation. Thus, the means of data provision can be customized according to the user's living situation. Some or all of the above-described processing in the provision unit may be performed using AI, or may be performed without using AI. For example, the provision unit can input the user's living situation into AI and have the AI execute the customization of the means of data provision. Specifically, the provision unit integrates multiple input data indicating the user's living situation (e.g., calendar schedule, current time, device activity log, activity data from wearable sensors, location information, sleep/exercise/meal records, etc.) and inputs these into an AI model. Examples of AI input include user ID “U567”, today's calendar schedule (3 meetings, 2 transfers), current time “14:00”, activity data (8,000 steps, heart rate 80), device usage status (using PC, not using smartphone), sleep time (6 hours), meal record (lunch completed), etc. The AI model uses a living situation estimation network (e.g., time-series RNN or Transformer-based multivariate classification model) to output living situation labels or scores such as “busy”, “relaxed”, “in transit”, “on break”, etc., from the input data. Output examples include “busy: 0.85, relaxed: 0.10” or “in transit: 0.70, on break: 0.20”. The provision unit inputs these living situation scores into threshold judgment (e.g., busy>0.7 for simplification, relaxed>0.7 for detail, in transit>0.6 for prioritizing voice output) or provision parameter control logic, and dynamically customizes the means of data provision (text summarization, graph simplification, voice reading, notification format, etc.). For example, in a busy state, only summary text or key indicators are returned; in a relaxed state, detailed analysis reports or multi-item graphs are provided; and in transit, data is provided via voice output or notification format. For AI model training, supervised learning using datasets correlating living situation data with user satisfaction and usage efficiency, or reinforcement learning utilizing user feedback, is employed. Furthermore, the provision unit can accumulate each user's living patterns and past provision history, and automatically adjust individually optimized customization logic. The technical effect is that automatic optimization of data provision means according to the user's living situation and usage environment can greatly reduce information overload and the risk of erroneous operations, and significantly improve overall system provision efficiency and user satisfaction. Unlike conventional uniform provision means or manual customization by human operators, automatic analysis of high-dimensional living situation data and dynamic customization logic realize computer technology-specific optimization of data provision. Specific application fields include situation-linked output for businessperson dashboards, situation-specific data provision for doctors and nurses in medical settings, learning support linked to student living situations in education, hands-free notifications for field workers, and other diverse business scenes requiring optimization of data provision according to living situation.

The provision unit can estimate the user's emotion and determine the priority of data provision based on the estimated emotion. For example, when the user is relaxed, the provision unit provides all data equally. The provision unit may capture the user's facial expression with a camera and estimate emotion using an emotion estimation algorithm. For example, the provision unit calculates an emotion score based on changes in facial expression, and if it determines that the user is relaxed, it provides all data equally. Additionally, when the user is in a hurry, the provision unit prioritizes the provision of highly important data. For example, the provision unit records the user's voice and estimates emotion using voice analysis technology. By analyzing the tone and speed of the voice, if the provision unit determines that the user is in a hurry, it prioritizes the provision of highly important data. Furthermore, when the user is stressed, the provision unit prioritizes the provision of data with fewer errors. For example, the provision unit collects the user's biometric data (heart rate and skin conductance) with sensors and estimates emotion using an emotion estimation algorithm. By calculating emotion scores based on heart rate variability, if the provision unit determines that the user is stressed, it prioritizes the provision of data with fewer errors. Thus, the priority of data provision can be determined according to the user's emotion. Emotion estimation may be realized using, for example, an emotion engine or generative AI with emotion estimation functions. Generative AI may include text generation AI (e.g., LLM) or multimodal generative AI, but is not limited to these examples. Specifically, the provision unit simultaneously acquires multiple input data to estimate the user's emotional state (e.g., 128×128 pixel facial image tensor (RGB, 8 bit, 1 frame or time-series 5 frames), 16 kHz sampled WAV audio waveform (up to 30 seconds), heart rate (1 Hz sampling, 30 samples), skin conductance (1 Hz sampling, 30 samples), etc.) and inputs these into a multimodal AI model. For image input, a CNN-based facial expression recognition network is used; for audio input, an RNN or Transformer-based voice emotion recognition network; and for biometric data, a time-series attention model is used for feature extraction. The feature vectors of all modalities are integrated to output emotion labels (e.g., stress, relaxation, hurry, etc.) and emotion scores (continuous values from 0.0 to 1.0). Examples of AI input include cases where the user changes facial expressions in front of the camera while saying “I want the data right now,” and simultaneously the heart rate rises as measured by a wearable sensor. AI model output examples include “stress: 0.85, relaxation: 0.10, hurry: 0.70” or “relaxation: 0.95, stress: 0.05”. The provision unit inputs these emotion scores into threshold judgment (e.g., stress>0.8 for error reduction emphasis, relaxation>0.8 for equal provision, hurry>0.6 for priority to important data) or priority control logic, and dynamically adjusts the priority of data provision (priority provision of important data, priority provision of data with low error risk, equal provision of all data, etc.). For example, in a hurry state, only highly important data is returned first; in a stress state, template-based safe data is provided preferentially; and in a relaxed state, all data is provided equally. For AI model training, supervised learning using large paired datasets of facial expressions, voice, biometric data, and emotion labels is used, with cross-entropy loss or regression error as the loss function. Furthermore, the provision unit can accumulate each user's emotional response patterns and past data provision history, and automatically adjust individually optimized priority logic. The technical effect is that priority control of data provision according to the user's psychological state and usage situation enables rapid provision of important data, reduction of erroneous operations and error rates, improvement of user experience quality, and enhancement of overall system responsiveness and reliability. Unlike conventional uniform priority control or manual adjustment by human operators, combining multimodal emotion estimation in high-dimensional feature space with rule-based dynamic priority control realizes computer technology-specific optimization of data provision. Specific application fields include call center automatic response systems, priority provision of emergency data in medical settings, learning support with student emotion monitoring in education, hands-free terminals for field workers, and other diverse business scenes requiring priority control of data provision according to emotional state.

The provision unit can select an appropriate provision method by considering the user's geographic location information when providing data. For example, when the user is in a specific region, the provision unit prioritizes the provision of data related to that region. The provision unit acquires the user's current location using GPS data or IP address and prioritizes the provision of data related to that region. Furthermore, the provision unit can prioritize the provision of highly relevant data based on the user's current location. For example, the provision unit prioritizes the provision of data based on information related to the region where the user is currently located. Additionally, when the user is in transit, the provision unit selects the optimal data provision method based on the current location. For example, the provision unit considers the user's travel route and prioritizes the provision of highly relevant data. Thus, the optimal data provision method can be selected based on the user's geographic location information. Some or all of the above-described processing in the provision unit may be performed using AI, or may be performed without using AI. For example, the provision unit can input the user's geographic location information into AI and have the AI execute the selection of the optimal data provision method. Specifically, the provision unit acquires geographic location data such as GPS coordinates (latitude and longitude, e.g., 35.6895, 139.6917) obtained from the user terminal, region information estimated from IP address (prefecture/city level), and Wi-Fi access point information (BSSID list) as structured data. Examples of AI input include user ID “U789”, current location “Chiyoda-ku, Tokyo”, travel route (GPS track for the past 30 minutes), current time, and past data usage (e.g., “Check inventory at nearby stores”, “Get local event information”). The AI model vectorizes geographic location information and data provision request content and calculates a region relevance score (0.0-1.0). The AI model output includes region relevance scores and priority labels (e.g., high, medium, low) for each data provision request, with output examples such as “Request A: relevance 0.95 (priority)”, “Request B: relevance 0.20 (deferred)”. The provision unit inputs these scores into threshold judgment (e.g., priority provision for scores≥0.7) or priority assignment logic, and dynamically controls the provision order and method (map-linked graphs, region-specific summary tables, local notifications, etc.). When in transit, the provision unit evaluates the relevance of region information and data content along the travel route in a time series and provides data at the optimal timing. For AI model training, supervised learning using past data provision records and region information as teacher signals, or geographic clustering, is used. Furthermore, the provision unit can sequentially learn each user's movement patterns and region-specific usage trends and update the priority logic online. The technical effect is that by efficiently providing only data relevant to the user's current location and movement status, unnecessary processing load and erroneous provision can be greatly reduced, and overall system provision efficiency and user satisfaction can be improved. Unlike conventional simple keyword matching or manual region judgment by human operators, region relevance estimation and dynamic priority control in high-dimensional geographic space realize computer technology-specific optimization of data provision. Specific application fields include local event guide systems, region-specific data provision control in logistics sites, area-specific case data provision in sales sites, and tourist guide terminals, among other diverse business scenes requiring optimization of data provision based on geographic location information.

The provision unit can analyze the user's social media activity and propose means of provision when providing data. For example, the provision unit prioritizes the provision of data related to content mentioned by the user on social media. The provision unit analyzes the user's social media posts and prioritizes the provision of related data. Furthermore, the provision unit can prioritize the provision of data related to fields of high interest based on the user's social media activity. The provision unit analyzes the user's social media activity history and prioritizes the provision of data related to fields of high interest. Additionally, the provision unit analyzes the user's social media activity and prioritizes the provision of the most relevant data. For example, the provision unit prioritizes the provision of highly relevant data based on social media trends and follower count. Thus, the optimal means of data provision can be proposed based on the user's social media activity. Some or all of the above-described processing in the provision unit may be performed using AI, or may be performed without using AI. For example, the provision unit can input the user's social media activity data into AI and have the AI execute the proposal of optimal means of data provision. Specifically, the provision unit acquires the user's social media activity data (e.g., the latest 100 post texts, post dates, number of likes, number of retweets, follower count, trend word frequency, etc.) as a structured database and inputs this into the AI model. Examples of AI input include user ID “U234”, post content for the past 30 days (natural language text), engagement metrics for each post (e.g., 50 likes, 10 retweets), trend word list (e.g., “AI”, “inventory management”, “sales analysis”), etc. The AI model vectorizes post content using a natural language processing model (e.g., Transformer-based text classification network), performs interest field clustering and topic extraction, and calculates semantic relevance between data provision request content and post content, outputting relevance scores (0.0-1.0) and priority labels (high, medium, low). Output examples include “Request A: relevance 0.90 (priority)”, “Request B: relevance 0.15 (deferred)”, or “Sales analysis-related data: high priority”. The provision unit inputs these scores into threshold judgment (e.g., priority provision for scores≥0.7) or priority assignment logic, and dynamically controls the provision order and means (trend-linked graphs, interest field-specific reports, notification format, etc.). For AI model training, supervised learning using past data provision records and social media activity as teacher signals, or topic distribution clustering, is used. Furthermore, the provision unit can sequentially learn each user's interest fields and trend changes and update the priority logic online. The technical effect is that by efficiently providing only data relevant to the user's latest interests and social trends, unnecessary processing load and erroneous provision can be greatly reduced, and overall system provision efficiency and user satisfaction can be improved. Unlike conventional simple keyword matching or manual trend judgment by human operators, relevance estimation and dynamic priority control in high-dimensional semantic space realize computer technology-specific optimization of data provision. Specific application fields include marketing analysis support systems, trend-linked data provision in sales sites, interest field-specific learning support in education, and topic-linked data provision in customer support, among other diverse business scenes requiring optimization of data provision based on social media activity.

The system according to the embodiment is not limited to the above examples and can be variously modified as described below. Specifically, the system is designed to allow diverse variations in technical elements such as internal algorithms and data flow of main components (reception unit, generation unit, provision unit), AI model architecture, input/output data formats, user interface, database types, communication protocols, sensor device types, learning methods, parameter optimization techniques, and cloud-edge collaboration configurations. For example, the system may have various implementation options, such as a reception unit that accepts multimodal input (voice, text, image, gesture, etc.), a generation unit that combines multiple generation algorithms (Transformer-based large language models, RNN-based time-series analysis models, rule-based generation engines, etc.), a provision unit that dynamically selects output formats according to user attributes and device environment, and a database access unit that issues queries to heterogeneous databases (relational DB, NoSQL, time-series DB, graph DB, etc.). The system can also apply various AI model training methods, such as supervised learning, semi-supervised learning, reinforcement learning, transfer learning, and self-supervised learning, and select loss functions and optimization algorithms (e.g., Adam, SGD, RMSprop) according to the application. Furthermore, to enhance overall system scalability, advanced technologies such as microservice architecture, API gateway, event-driven design, distributed cluster configuration, and high-speed inference infrastructure using GPU/TPU can be introduced. The technical effect is that such diverse change tolerance greatly improves system flexibility, scalability, and maintainability, enabling rapid and accurate response to changes in user requirements and business environments. Specific application fields include corporate management analysis dashboards, data extraction/visualization systems in medical settings, learning history analysis in education, real-time inventory management in logistics, and customer support automation, among other diverse business scenes requiring customization according to industry, business type, and usage scale. Thus, the system realizes flexible system design, operation, and optimization unique to computer technology, going beyond mere automation of human tasks.

The reception unit can analyze the user's past instruction history and preferentially propose instruction methods frequently used by the user. For example, if the user has frequently used voice instructions in the past, the reception unit preferentially proposes voice instructions. The reception unit can also predict and propose instruction methods used during specific time periods based on the user's past instruction history. For example, if the user uses text instructions during a specific time period, the reception unit preferentially proposes text instructions during that time period. Furthermore, the reception unit can analyze the user's past instruction history and select the most efficient reception method. For example, if analysis of the user's past instruction history determines that voice instructions are the most efficient, the reception unit preferentially proposes voice instructions. Thus, the optimal reception method can be selected based on the user's past instruction history. Specifically, the reception unit maintains a time-series instruction history database for each user (e.g., a structured table including instruction reception date/time, instruction method (text, voice, command ID, etc.), reception terminal type, reception result, processing time, etc.) and inputs this into an AI model. The AI model uses an RNN or Transformer-based history analysis network specialized for time-series data analysis to extract features (frequency distribution of instruction methods, usage trends by time period, success rate by terminal, etc.) from the input history. Examples of AI input include user ID “U123”, instruction history for the past 30 days (e.g., 2024-06-01 09:00 text, 2024-06-01 12:00 voice, 2024-06-02 10:00 text . . . ), reception result for each instruction (success/failure), reception terminal (PC, smartphone, etc.), and environment information at reception (time period, day of week, location). The AI model output includes recommendation scores for each reception method (e.g., text 0.7, voice 0.2, command 0.1) and recommended methods by time period (e.g., morning: voice, afternoon: text), as structured data. Output examples include “09:00-12:00: voice instruction recommended, 12:00-18:00: text instruction recommended” or “Overall recommendation: voice 0.65, text 0.30, command 0.05”. The reception unit uses these recommendation scores to preferentially display recommendation buttons on the user interface or automatically select the default reception method. For AI model training, supervised learning using each user's history data and actual reception success rate/processing efficiency as teacher signals, or clustering for user type classification, is used. Furthermore, the reception unit can sequentially learn changes in each user's usage trends and update the recommendation logic online. The technical effect is that automatic proposal of optimized reception methods for each user can greatly reduce the effort and error rate of reception operations, and significantly improve overall system reception efficiency and user satisfaction. Unlike conventional uniform reception method presentation or manual history reference by human operators, automatic analysis of high-dimensional history data and dynamic recommendation logic realize computer technology-specific optimization of reception. Specific application fields include automation of reception in enterprise business systems, optimal reception UI presentation for doctors and nurses in medical settings, customization of reception methods for each student in education, and operator workload reduction in call centers, among other diverse business scenes requiring optimization of reception based on history.

The generation unit can analyze the user's instructions and adjust the level of detail of SQL query generation based on the importance of the instructions. For example, for highly important instructions, the generation unit generates detailed SQL queries. The importance of the user's instructions is evaluated, and for highly important instructions, detailed SQL queries are generated. For less important instructions, concise SQL queries may be generated. Furthermore, the generation unit can dynamically adjust the level of detail of SQL queries according to importance. Thus, the level of detail of SQL queries can be adjusted according to the importance of the instructions. Specifically, the generation unit calculates an importance score (e.g., continuous value from 0.0 to 1.0, or labels such as low, medium, high) for each instruction received from the user, and dynamically controls SQL query generation parameters (number of columns in SELECT clause, number of conditions in WHERE clause, presence of GROUP BY or ORDER BY, complexity of JOIN clause, LIMIT clause settings, etc.) based on this score. Examples of AI input include “I want to obtain sales data for 2023 (importance: high)”, “Tell me the inventory count for this month (importance: medium)”, “Check yesterday's login history (importance: low)”, etc. The AI model inputs features such as instruction content, past usage history, business rules, and user attributes, and outputs importance scores using an importance estimation network (e.g., Transformer-based classification or regression model). AI model output examples include “Instruction A: importance 0.95”, “Instruction B: importance 0.40”, etc. When importance is high, the generation unit generates SQL queries including detailed aggregation and multi-condition filters; when importance is low, it generates concise SQL queries extracting only the minimum necessary columns. Furthermore, the generation unit can dynamically adjust query execution priority and resource allocation according to importance. For AI model training, supervised learning using datasets of past instructions and corresponding business deliverables, or reinforcement learning utilizing user feedback, is used. The technical effect is that SQL query generation optimized for business importance and urgency enables system-wide resource optimization, response time reduction, error risk reduction, and improvement of user satisfaction. Unlike conventional uniform query generation or manual adjustment by human operators, combining importance estimation in high-dimensional feature space with dynamic generation control realizes computer technology-specific optimization of query generation. Specific application fields include extraction of key indicators in management analysis dashboards, emergency data extraction in medical settings, report generation by case priority in sales, and data extraction by task importance in education, among other diverse business scenes requiring query generation control according to importance.

The provision unit can analyze the user's past data usage history and select the optimal provision method when responding to the user with data extracted based on the generated SQL query. For example, the provision unit preferentially proposes data provision methods frequently used by the user in the past. The provision unit analyzes the user's past data usage history and preferentially proposes frequently used data provision methods. Furthermore, the provision unit can predict and propose data provision methods used during specific time periods based on the user's past data usage history. Additionally, the provision unit can analyze the user's past data usage history and select the most efficient data provision method. Thus, the optimal provision method can be selected based on the user's past data usage history. Specifically, the provision unit maintains a time-series data usage history database for each user (e.g., a structured table including reception date/time of each data provision request, provision method (text, table, graph, image, etc.), terminal type, usage result, processing time, etc.) and inputs this into an AI model. Examples of AI input include user ID “U123”, data usage history for the past 30 days (e.g., 2024-06-01 09:00 text, 2024-06-01 12:00 graph, 2024-06-02 10:00 table . . . ), usage result for each provision method (satisfied, dissatisfied, re-request), terminal (PC, smartphone, etc.), and environment information at the time of use (time period, day of week, location). The AI model uses an RNN or Transformer-based history analysis network specialized for time-series data analysis to extract features (frequency distribution of provision methods, usage trends by time period, satisfaction by terminal, etc.) from the input history. The AI model output includes recommendation scores for each provision method (e.g., text 0.7, graph 0.2, table 0.1) and recommended methods by time period (e.g., morning: graph, afternoon: text), as structured data. Output examples include “09:00-12:00: graph recommended, 12:00-18:00: text recommended” or “Overall recommendation: graph 0.65, text 0.30, table 0.05”. The provision unit uses these recommendation scores to preferentially display recommendation buttons on the user interface or automatically select the default provision method. For AI model training, supervised learning using each user's history data and actual usage satisfaction/processing efficiency as teacher signals, or clustering for user type classification, is used. Furthermore, the provision unit can sequentially learn changes in each user's usage trends and update the recommendation logic online. The technical effect is that automatic proposal of optimized data provision methods for each user can greatly reduce the effort and error rate of provision operations, and significantly improve overall system provision efficiency and user satisfaction. Unlike conventional uniform provision method presentation or manual history reference by human operators, automatic analysis of high-dimensional history data and dynamic recommendation logic realize computer technology-specific optimization of data provision. Specific application fields include automation of data provision in enterprise business systems, optimal provision UI presentation for doctors and nurses in medical settings, customization of data provision methods for each student in education, and usage history-linked data provision in customer support, among other diverse business scenes requiring optimization of data provision based on history.

The reception unit can estimate the user's emotion and adjust the timing of receiving instructions based on the estimated emotion. For example, when the user is stressed, the reception of instructions can be temporarily delayed until the user relaxes. The user's facial expression is captured by a camera, and emotion is estimated using an emotion estimation algorithm. An emotion score is calculated based on changes in facial expression, and if the user is determined to be stressed, the reception of instructions is temporarily delayed. Conversely, when the user is relaxed, instructions can be received immediately and processing can begin promptly. The user's voice is recorded, and emotion is estimated using voice analysis technology. By analyzing the tone and speed of the voice, if the user is determined to be relaxed, instructions can be received immediately. Thus, the timing of receiving instructions can be adjusted according to the user's emotion. Specifically, the reception unit simultaneously acquires multiple input data to estimate the user's emotional state (image tensor, audio waveform data, biometric sensor values, etc.) and inputs these into a multimodal AI model. The AI model accepts image input as a 128×128 pixel facial image tensor (RGB, 8 bit, 1 frame or time-series 5 frames), audio input as a 16 kHz sampled WAV waveform (up to 30 seconds), and biometric data as heart rate (1 Hz sampling, 30 samples), skin conductance (1 Hz sampling, 30 samples), etc. Examples of input include cases where the user changes facial expressions in front of the camera while saying “I want the data right now,” and simultaneously the heart rate rises as measured by a wearable sensor. For image input, a CNN-based facial expression recognition network is used; for audio input, an RNN or Transformer-based voice emotion recognition network; and for biometric data, a time-series attention model is used for feature extraction. The feature vectors of all modalities are integrated to output emotion labels (e.g., stress, relaxation, tension, hurry, etc.) and emotion scores (continuous values from 0.0 to 1.0). Output examples include “stress: 0.85, relaxation: 0.10, hurry: 0.70” or “relaxation: 0.95, stress: 0.05”. The reception unit inputs these emotion scores into threshold judgment (e.g., stress>0.8 for temporary delay, hurry>0.6 for immediate reception) or priority assignment logic, and dynamically controls the timing of receiving instructions. For example, when stress is high, a 5-second delay timer is activated; when relaxation is high, instructions are immediately transferred to the natural language analysis unit. For AI model training, supervised learning using large paired datasets of facial expressions, voice, biometric data, and emotion labels is used, with cross-entropy loss or regression error as the loss function. Furthermore, the reception unit can accumulate each user's emotional response patterns and automatically adjust individually optimized thresholds and delay parameters. The technical effect is that psychological burden and risk of erroneous operations for the user can be reduced, the quality of user experience can be greatly improved, and overall system responsiveness and reliability can be enhanced. Unlike conventional simple timing control or manual judgment by human operators, combining multimodal emotion estimation in high-dimensional feature space with rule-based dynamic control realizes computer technology-specific optimization of reception. Specific application fields include call center automatic response systems, reception terminals with stress management in medical settings, Q&A systems with student emotion monitoring in education, and hands-free reception terminals for field workers, among other diverse business scenes requiring timing control of reception according to emotional state.

The generation unit can estimate the user's emotion and adjust the method of generating SQL queries based on the estimated emotion. For example, when the user is relaxed, the generation unit generates detailed SQL queries. The user's facial expression is captured by a camera, and emotion is estimated using an emotion estimation algorithm. An emotion score is calculated based on changes in facial expression, and if the user is determined to be relaxed, detailed SQL queries are generated. Conversely, when the user is in a hurry, concise SQL queries can be generated. The user's voice is recorded, and emotion is estimated using voice analysis technology. By analyzing the tone and speed of the voice, if the user is determined to be in a hurry, concise SQL queries can be generated. Thus, the method of generating SQL queries can be adjusted according to the user's emotion. Specifically, the generation unit simultaneously acquires multiple input data to estimate the user's emotional state (e.g., 128×128 pixel facial image tensor (RGB, 8 bit, 1 frame or time-series 5 frames), 16 kHz sampled WAV audio waveform (up to 30 seconds), heart rate (1 Hz sampling, 30 samples), skin conductance (1 Hz sampling, 30 samples), etc.) and inputs these into a multimodal AI model. For image input, a CNN-based facial expression recognition network is used; for audio input, an RNN or Transformer-based voice emotion recognition network; and for biometric data, a time-series attention model is used for feature extraction. The feature vectors of all modalities are integrated to output emotion labels (e.g., stress, relaxation, hurry, etc.) and emotion scores (continuous values from 0.0 to 1.0). Examples of AI input include cases where the user changes facial expressions in front of the camera while saying “I want the data right now,” and simultaneously the heart rate rises as measured by a wearable sensor. AI model output examples include “stress: 0.85, relaxation: 0.10, hurry: 0.70” or “relaxation: 0.95, stress: 0.05”. The generation unit inputs these emotion scores into threshold judgment (e.g., stress>0.8 for error reduction emphasis, relaxation>0.8 for detail, hurry>0.6 for simplification) or generation parameter control logic, and dynamically adjusts the method of generating SQL queries (number of items in SELECT clause, number of conditions in WHERE clause, presence of JOIN clause, LIMIT clause settings, etc.). For example, in a relaxed state, SQL queries including detailed aggregation and multi-condition filters are generated; in a hurry state, SQL queries extracting only the minimum necessary columns are generated; and in a stress state, template-based safe SQL is generated to minimize the risk of syntax or execution errors. For AI model training, supervised learning using large paired datasets of facial expressions, voice, biometric data, and emotion labels is used, with cross-entropy loss or regression error as the loss function. Furthermore, the generation unit can accumulate each user's emotional response patterns and past query generation history, and automatically adjust individually optimized generation parameters. The technical effect is that SQL query generation according to the user's psychological state and usage situation enables reduction of erroneous operations and error rates, improvement of user experience quality, and enhancement of overall system responsiveness and reliability. Unlike conventional uniform query generation or manual adjustment by human operators, combining multimodal emotion estimation in high-dimensional feature space with rule-based dynamic generation control realizes computer technology-specific optimization of query generation. Specific application fields include call center automatic response systems, data extraction with stress management in medical settings, learning history analysis with student emotion monitoring in education, and hands-free reception terminals for field workers, among other diverse business scenes requiring query generation control according to emotional state.

The provision unit can estimate the user's emotion and adjust the method of data provision based on the estimated emotion. For example, when the user is relaxed, the provision unit provides detailed data. The user's facial expression is captured by a camera, and emotion is estimated using an emotion estimation algorithm. An emotion score is calculated based on changes in facial expression, and if the user is determined to be relaxed, detailed data is provided. Conversely, when the user is in a hurry, concise data can be provided. The user's voice is recorded, and emotion is estimated using voice analysis technology. By analyzing the tone and speed of the voice, if the user is determined to be in a hurry, concise data can be provided. Thus, the method of data provision can be adjusted according to the user's emotion. Specifically, the provision unit simultaneously acquires multiple input data to estimate the user's emotional state (e.g., 128×128 pixel facial image tensor (RGB, 8 bit, 1 frame or time-series 5 frames), 16 kHz sampled WAV audio waveform (up to 30 seconds), heart rate (1 Hz sampling, 30 samples), skin conductance (1 Hz sampling, 30 samples), etc.) and inputs these into a multimodal AI model. For image input, a CNN-based facial expression recognition network is used; for audio input, an RNN or Transformer-based voice emotion recognition network; and for biometric data, a time-series attention model is used for feature extraction. The feature vectors of all modalities are integrated to output emotion labels (e.g., stress, relaxation, hurry, etc.) and emotion scores (continuous values from 0.0 to 1.0). Examples of AI input include cases where the user changes facial expressions in front of the camera while saying “I want the data right now,” and simultaneously the heart rate rises as measured by a wearable sensor. AI model output examples include “stress: 0.85, relaxation: 0.10, hurry: 0.70” or “relaxation: 0.95, stress: 0.05”. The provision unit inputs these emotion scores into threshold judgment (e.g., stress>0.8 for error reduction emphasis, relaxation>0.8 for detail, hurry>0.6 for simplification) or provision parameter control logic, and dynamically adjusts the method of data provision (number of columns in tables, level of detail in graphs, presence of explanatory text, limitation of data count, etc.). For example, in a relaxed state, data including detailed aggregation and multi-item graphs is provided; in a hurry state, only the minimum necessary summary data is returned; and in a stress state, only template-based safe data is provided to minimize the risk of syntax or execution errors. For AI model training, supervised learning using large paired datasets of facial expressions, voice, biometric data, and emotion labels is used, with cross-entropy loss or regression error as the loss function. Furthermore, the provision unit can accumulate each user's emotional response patterns and past data provision history, and automatically adjust individually optimized provision parameters. The technical effect is that data provision according to the user's psychological state and usage situation enables reduction of erroneous operations and error rates, improvement of user experience quality, and enhancement of overall system responsiveness and reliability. Unlike conventional uniform data provision or manual adjustment by human operators, combining multimodal emotion estimation in high-dimensional feature space with rule-based dynamic provision control realizes computer technology-specific optimization of data provision. Specific application fields include call center automatic response systems, data provision with stress management in medical settings, learning history analysis with student emotion monitoring in education, and hands-free reception terminals for field workers, among other diverse business scenes requiring data provision control according to emotional state.

The reception unit can perform filtering at the time of receiving instructions based on the user's current project or field of interest. For example, the reception unit preferentially receives instructions related to the user's ongoing project. The reception unit prioritizes the reception of instructions related to the project name or progress. Furthermore, the reception unit can prioritize the reception of highly relevant instructions based on the user's field of interest. The field of interest is identified based on the user's past activity history or survey results, and related instructions are preferentially received. Thus, instructions can be filtered based on the user's current project or field of interest. Specifically, the reception unit maintains, for each user, current project information (e.g., project ID, name, progress, start date/end date, related tags, etc.) and field of interest information (e.g., keyword list, survey responses, topic distribution extracted from past instructions, etc.) as a structured database. Examples of AI input include user ID “U456”, current project “Management Analysis 2024” (progress 80%, tags: sales, inventory), field of interest “Sales Report”, “Inventory Management”, past 30 instructions (natural language text or command ID), etc. The AI model vectorizes the input project and field of interest information and new reception instructions (e.g., “Display sales trends for 2024 as a graph”) and calculates semantic relevance. The AI model output includes relevance scores for each instruction (e.g., 0.92, 0.15, etc.) and reception decision labels (accepted, pending, rejected), as structured data. Output examples include “Instruction A: relevance 0.95 (accepted)”, “Instruction B: relevance 0.10 (rejected)”, etc. The reception unit inputs these relevance scores into threshold judgment (e.g., accepted for scores≥0.7, rejected for scores<0.3) or priority assignment logic, and dynamically controls reception order and filtering. For AI model training, supervised learning using past reception records and project/field of interest correspondence as teacher signals, or clustering in semantic vector space, is used. Furthermore, the reception unit can sequentially learn changes in each user's project progress and field of interest and update the filtering logic online. The technical effect is that by efficiently receiving only instructions relevant to the user's business situation and interests, unnecessary processing load and erroneous reception can be greatly reduced, and overall system reception efficiency and user satisfaction can be improved. Unlike conventional simple keyword matching or manual reception judgment by human operators, relevance estimation and dynamic filtering in high-dimensional semantic space realize computer technology-specific optimization of reception. Specific application fields include automation of reception in project management systems, topic-based reception in R&D sites, optimization of assignment reception for each student in education, and case-based reception control in sales, among other diverse business scenes requiring optimization of reception based on project or field of interest.

The generation unit can apply different generation algorithms according to the category of instructions when generating SQL queries. For example, for instructions related to sales data, a dedicated generation algorithm for sales data is applied. When instructions related to sales data are received, the generation unit applies a dedicated generation algorithm for sales data to generate SQL queries. Similarly, for instructions related to customer data, a dedicated generation algorithm for customer data can be applied. When instructions related to customer data are received, the generation unit applies a dedicated generation algorithm for customer data to generate SQL queries. Thus, appropriate generation algorithms can be applied according to the category of instructions. Specifically, the generation unit tokenizes and parses the instruction text received from the user in the natural language analysis unit, and automatically determines the instruction category (e.g., sales, customer, inventory, purchasing, expenses, etc.) using a classification network (e.g., Transformer-based text classification model). Examples of AI input include “I want to obtain sales data for 2023”, “Tell me the inventory count for this month”, “Display the customer list for 2022”, etc. The AI model output includes category labels (e.g., sales, inventory, customer) and confidence scores for each category (e.g., sales 0.95, inventory 0.03, customer 0.02). Output examples include “Instruction A: sales category”, “Instruction B: inventory category”, etc. The generation unit selects and applies a dedicated SQL template generation algorithm for each category according to the category determination result (e.g., sales table JOIN, period aggregation, department-wise GROUP BY for sales data; customer attribute filter, history JOIN for customer data; inventory table JOIN, extraction of latest inventory count for inventory data) to generate SQL queries. Furthermore, different schema information and business rules (e.g., monthly aggregation for sales, daily update for inventory) are automatically applied for each category to reduce syntax errors and business logic inconsistencies. For AI model training, supervised learning using large paired datasets of category-labeled instruction texts and corresponding SQL queries, or automatic template generation for each category, is used. The technical effect is that algorithm selection optimized for instruction content greatly improves the accuracy, efficiency, and maintainability of SQL query generation, and reduces the risk of erroneous generation and deviation from business logic. Unlike conventional uniform query generation or manual category selection by human operators, combining category classification in high-dimensional semantic space with dynamic algorithm selection realizes computer technology-specific optimization of query generation. Specific application fields include extraction of indicator-specific data in management analysis dashboards, category-specific data extraction for patients, tests, and medications in medical settings, report generation by case, customer, and sales category in sales, and extraction of grade, attendance, and assignment category data in education, among other diverse business scenes requiring query generation control according to category.

The provision unit can select an appropriate provision method by considering the user's geographic location information when providing data. For example, when the user is in a specific region, the provision unit prioritizes the provision of data related to that region. The user's current location is acquired using GPS data or IP address, and data related to that region is prioritized for provision. Furthermore, the provision unit can prioritize the provision of highly relevant data based on the user's current location. The provision unit prioritizes the provision of data based on information related to the region where the user is currently located. Thus, the optimal data provision method can be selected based on the user's geographic location information. Specifically, the provision unit acquires geographic location data such as GPS coordinates (latitude and longitude, e.g., 35.6895, 139.6917) obtained from the user terminal, region information estimated from IP address (prefecture/city level), and Wi-Fi access point information (BSSID list) as structured data. Examples of AI input include user ID “U789”, current location “Chiyoda-ku, Tokyo”, travel route (GPS track for the past 30 minutes), current time, and past data usage (e.g., “Check inventory at nearby stores”, “Get local event information”). The AI model vectorizes geographic location information and data provision request content and calculates a region relevance score (0.0-1.0). The AI model output includes region relevance scores and priority labels (e.g., high, medium, low) for each data provision request, with output examples such as “Request A: relevance 0.95 (priority)”, “Request B: relevance 0.20 (deferred)”. The provision unit inputs these scores into threshold judgment (e.g., priority provision for scores≥0.7) or priority assignment logic, and dynamically controls the provision order and method (map-linked graphs, region-specific summary tables, local notifications, etc.). When in transit, the provision unit evaluates the relevance of region information and data content along the travel route in a time series and provides data at the optimal timing. For AI model training, supervised learning using past data provision records and region information as teacher signals, or geographic clustering, is used. Furthermore, the provision unit can sequentially learn each user's movement patterns and region-specific usage trends and update the priority logic online. The technical effect is that by efficiently providing only data relevant to the user's current location and movement status, unnecessary processing load and erroneous provision can be greatly reduced, and overall system provision efficiency and user satisfaction can be improved. Unlike conventional simple keyword matching or manual region judgment by human operators, region relevance estimation and dynamic priority control in high-dimensional geographic space realize computer technology-specific optimization of data provision. Specific application fields include local event guide systems, region-specific data provision control in logistics sites, area-specific case data provision in sales sites, and tourist guide terminals, among other diverse business scenes requiring optimization of data provision based on geographic location information.

The provision unit can analyze the user's social media activity and propose means of provision when providing data. For example, the provision unit prioritizes the provision of data related to content mentioned by the user on social media. The provision unit analyzes the user's social media posts and prioritizes the provision of related data. Furthermore, the provision unit can prioritize the provision of data related to fields of high interest based on the user's social media activity. The provision unit analyzes the user's social media activity history and prioritizes the provision of data related to fields of high interest. Thus, the optimal means of data provision can be proposed based on the user's social media activity. Specifically, the provision unit acquires the user's social media activity data (e.g., the latest 100 post texts, post dates, number of likes, number of retweets, follower count, trend word frequency, etc.) as a structured database and inputs this into the AI model. Examples of AI input include user ID “U234”, post content for the past 30 days (natural language text), engagement metrics for each post (e.g., 50 likes, 10 retweets), trend word list (e.g., “AI”, “inventory management”, “sales analysis”), etc. The AI model vectorizes post content using a natural language processing model (e.g., Transformer-based text classification network), performs interest field clustering and topic extraction, and calculates semantic relevance between data provision request content and post content, outputting relevance scores (0.0-1.0) and priority labels (high, medium, low). Output examples include “Request A: relevance 0.90 (priority)”, “Request B: relevance 0.15 (deferred)”, or “Sales analysis-related data: high priority”. The provision unit inputs these scores into threshold judgment (e.g., priority provision for scores≥0.7) or priority assignment logic, and dynamically controls the provision order and means (trend-linked graphs, interest field-specific reports, notification format, etc.). For AI model training, supervised learning using past data provision records and social media activity as teacher signals, or topic distribution clustering, is used. Furthermore, the provision unit can sequentially learn each user's interest fields and trend changes and update the priority logic online. The technical effect is that by efficiently providing only data relevant to the user's latest interests and social trends, unnecessary processing load and erroneous provision can be greatly reduced, and overall system provision efficiency and user satisfaction can be improved. Unlike conventional simple keyword matching or manual trend judgment by human operators, relevance estimation and dynamic priority control in high-dimensional semantic space realize computer technology-specific optimization of data provision. Specific application fields include marketing analysis support systems, trend-linked data provision in sales sites, interest field-specific learning support in education, and topic-linked data provision in customer support, among other diverse business scenes requiring optimization of data provision based on social media activity.

The following is a brief explanation of the processing flow of Example of the Embodiment. Specifically, the system operates in cooperation among the reception unit, generation unit, and provision unit modules, accepting various types of user instruction input (text, voice, command, etc.), and realizes a series of technical processing flows including natural language analysis, AI inference, SQL query generation, database access, data formatting, response generation, and reply to the user. The reception unit acquires various attribute data such as user input content, past instruction history, emotional state, project information, geographic location information, social media activity, etc., and performs analysis, filtering, and priority assignment using AI models. The generation unit receives instruction content and attribute information from the reception unit, and utilizes natural language processing technology (e.g., Transformer-based large language models, keyword extraction, syntactic analysis, etc.) to automatically generate SQL queries, dynamically controlling generation parameters according to instruction importance, category, emotional state, relevance, etc. The provision unit transfers the generated SQL queries to the database access unit, extracts data from heterogeneous databases such as relational DB and NoSQL, and formats and replies the data in the optimal format (text, table, graph, image, etc.) based on the user's emotion, usage history, geographic location, social media activity, etc. Various data structures such as structured databases, vector representations, time-series data, image tensors, etc., are exchanged among modules, and AI model input/output examples and subsequent processing flows are clearly designed. The technical effect is that flexible reception, generation, and provision control according to user attributes and business situations can greatly improve overall system responsiveness, accuracy, reliability, and user satisfaction. Specific application fields include management analysis dashboards, data extraction/visualization in medical settings, learning history analysis in education, real-time inventory management in logistics, and customer support automation.

Step 1: The reception unit receives instructions from the user. User instructions include text input, voice instructions, and specific commands. For example, the reception unit can receive instructions in text chat format, voice chat format, or real-time chat format. Step 2: The generation unit analyzes the instructions received by the reception unit and generates SQL queries. The generation unit utilizes generative AI to analyze the user's instructions using natural language processing technology, keyword extraction technology, and grammatical analysis technology, and generates appropriate SQL queries. For example, the user's instruction “I want to obtain sales data for 2023” is analyzed and an SQL query such as “SELECT * FROM sales WHERE year=2023” is generated. Step 3: The provision unit extracts data based on the SQL query generated by the generation unit and replies the result to the user. The provision unit extracts data using appropriate methods according to the type of database and filters data based on extraction conditions. For example, based on the SQL query “SELECT * FROM sales WHERE year=2023”, sales data for 2023 is extracted and visually displayed as text, graph, or chart. Specifically, the system receives instruction input from the user (e.g., text “I want to obtain sales data for 2023”, voice “Tell me the inventory count for this month”, etc.) in the reception unit, and transfers the input content as structured data (command ID, attribute values, time, etc.) to the generation unit. The generation unit tokenizes and parses the instruction text using a natural language analysis AI (e.g., Transformer-based large language model) and inputs it into the SQL query generation network. Examples of AI input include “I want to obtain sales data for 2023”, “Tell me the inventory count for this month”, etc. The AI model output is an SQL query string (e.g., “SELECT * FROM sales WHERE year=2023”, “SELECT stock FROM inventory WHERE month=‘2023-06’”), with output examples such as “SELECT * FROM sales WHERE year=2023”, “SELECT stock FROM inventory WHERE month=‘2023-06’”. The provision unit transfers the SQL query received from the generation unit to the database access unit and issues queries to relational databases or NoSQL databases. The database access unit obtains matrix-form data (e.g., each row is a record, each column is an attribute value) as query execution results, and performs filtering or sorting processing as needed based on extraction conditions (WHERE clause, LIMIT clause, etc.). The provision unit passes the obtained data to the response generation unit, which, based on the user's instruction content and past dialogue history, formats the data in the appropriate format such as text (e.g., “Sales for 2023 is 10 million yen”), table (HTML table or CSV), or graph image (bar graph, line graph, etc.). For graph generation, data visualization libraries (e.g., matplotlib, Plotly, etc.) may be used to output image data (PNG, SVG, etc.). Furthermore, the response generation unit automatically selects the optimal display format according to the user's device environment and past usage history. The technical effect is that by absorbing differences in database types and output formats and realizing a unified data extraction and response generation flow, overall system flexibility and scalability are improved, enabling rapid and accurate response to diverse user needs. Specific application fields include management dashboards, automatic generation of sales reports, inventory management systems, medical data analysis, and visualization of learning history in education. Thus, the system realizes efficiency and reliability improvement in data extraction, visualization, and response generation unique to computer technology, going beyond mere automation of human tasks.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, generation unit, and provision unit is implemented by at least one of, for example, the smart device 14 and the data processing apparatus 12. For example, the reception unit is implemented by a control unit 46A of the smart device 14 and receives text input or voice instructions from a user. The generation unit is implemented, for example, by a specific processing unit 290 of the data processing apparatus 12, analyzes the user's instructions using a generation AI, and generates an SQL query. The provision unit is implemented, for example, by the specific processing unit 290 of the data processing apparatus 12, extracts data based on the generated SQL query, and returns the result to the user. The correspondence between each unit and the apparatus or control unit is not limited to the examples described above and various modifications are possible.

### Second Embodiment

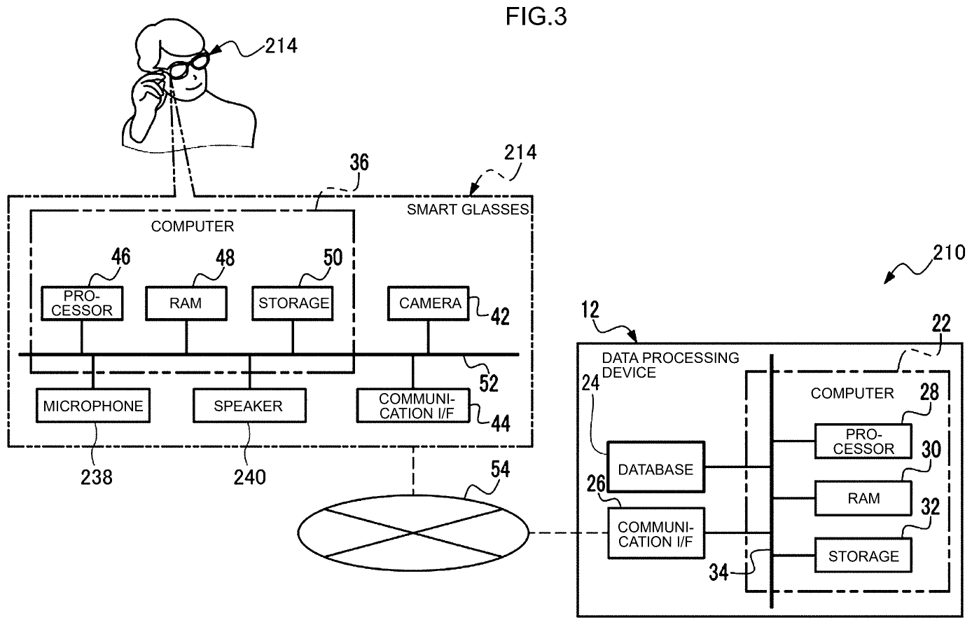

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

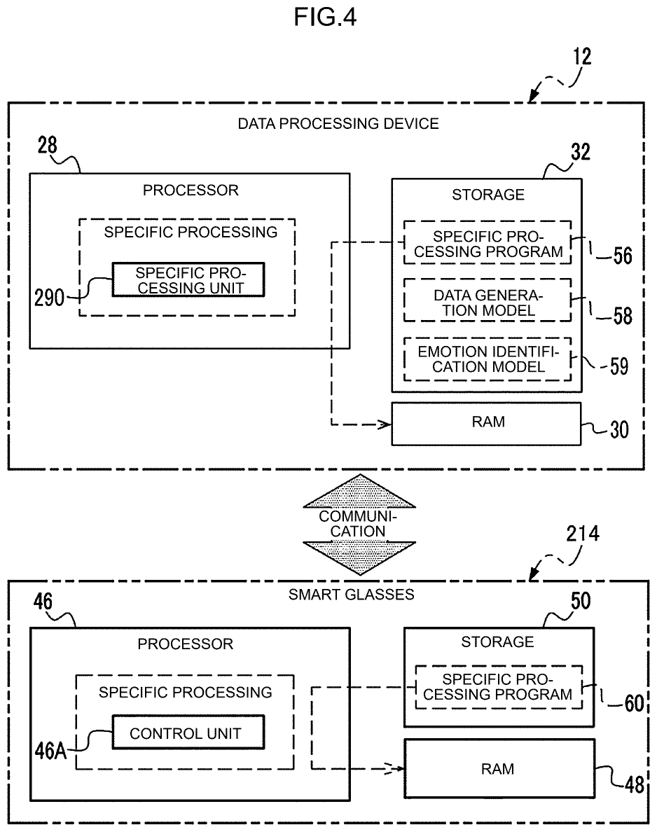

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, generation unit, and provision unit is implemented by at least one of, for example, the smart glasses 214 and the data processing apparatus 12. For example, the reception unit is implemented by a control unit 46A of the smart glasses 214 and receives text input or voice instructions from a user. The generation unit is implemented, for example, by a specific processing unit 290 of the data processing apparatus 12, analyzes the user's instructions using a generation AI, and generates an SQL query. The provision unit is implemented, for example, by the specific processing unit 290 of the data processing apparatus 12, extracts data based on the generated SQL query, and returns the result to the user. The correspondence between each unit and the apparatus or control unit is not limited to the examples described above and various modifications are possible.

### Third Embodiment

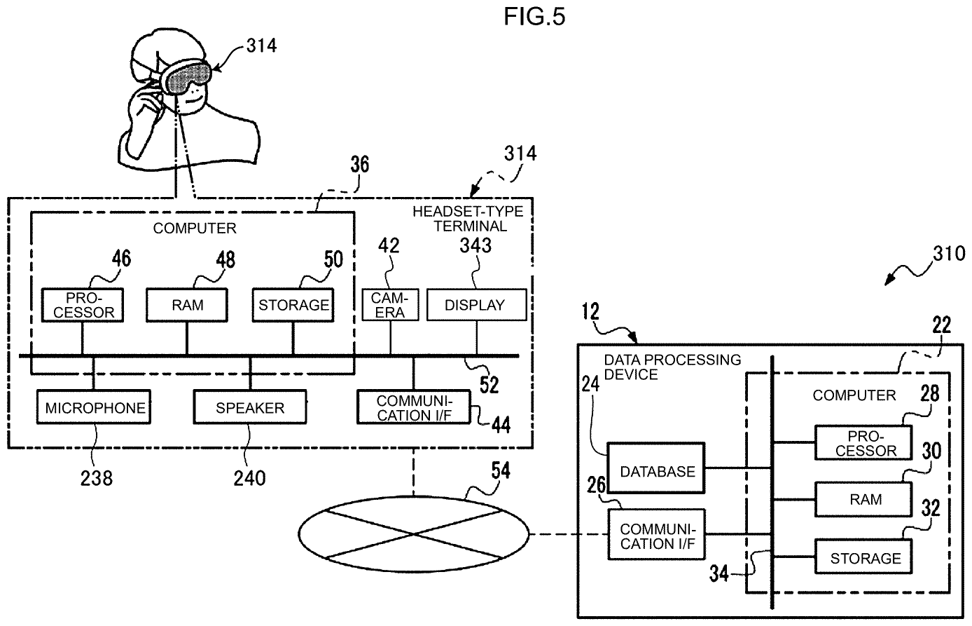

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

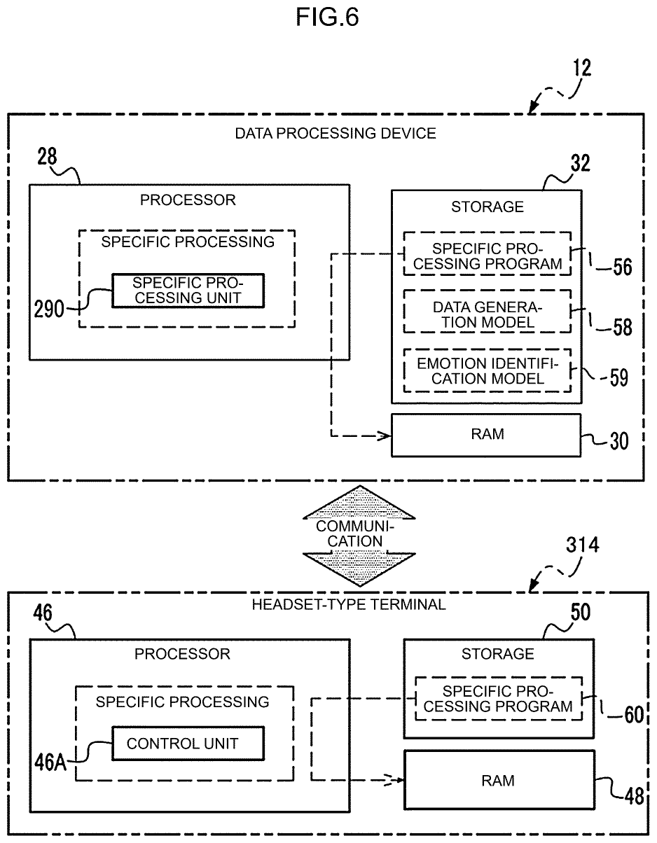

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, generation unit, and provision unit is implemented by at least one of, for example, the headset-type terminal 314 and the data processing apparatus 12. For example, the reception unit is implemented by a control unit 46A of the headset-type terminal 314 and receives text input or voice instructions from a user. The generation unit is implemented, for example, by a specific processing unit 290 of the data processing apparatus 12, analyzes the user's instructions using a generation AI, and generates an SQL query. The provision unit is implemented, for example, by the specific processing unit 290 of the data processing apparatus 12, extracts data based on the generated SQL query, and returns the result to the user. The correspondence between each unit and the apparatus or control unit is not limited to the examples described above and various modifications are possible.

### Fourth Embodiment

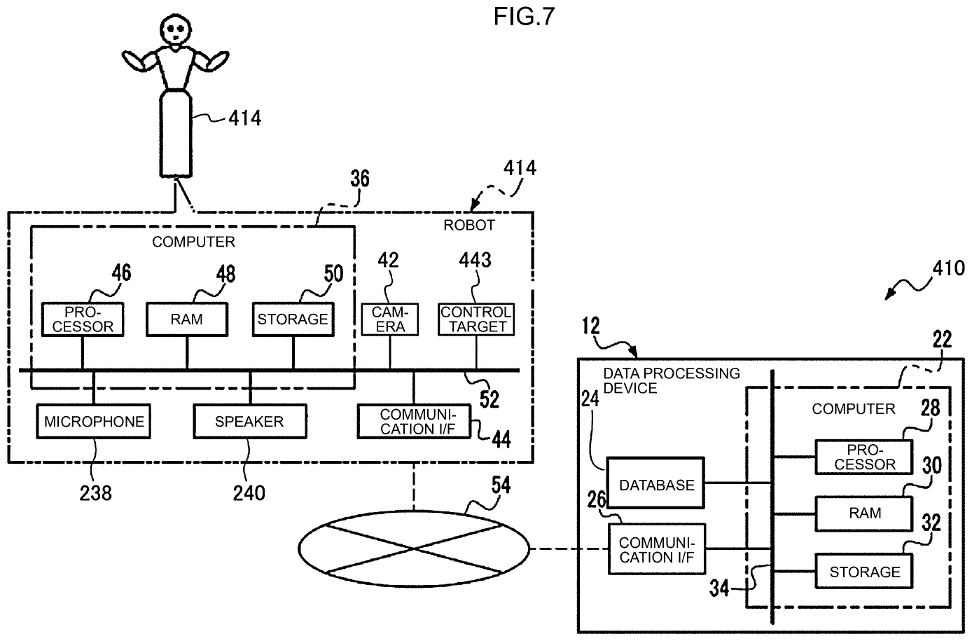

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

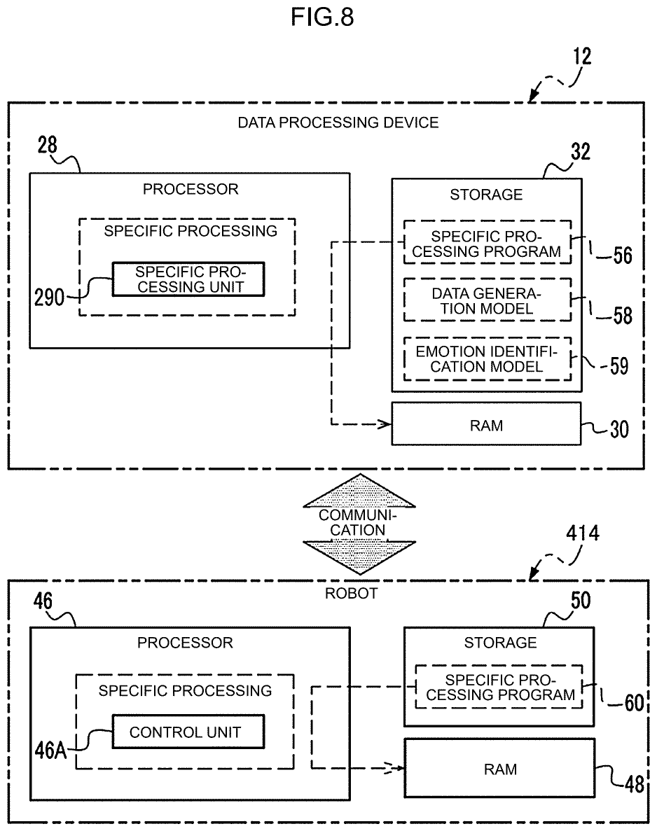

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, generation unit, and provision unit is implemented by at least one of, for example, the robot 414 and the data processing apparatus 12. For example, the reception unit is implemented by a control unit 46A of the robot 414 and receives text input or voice instructions from a user. The generation unit is implemented, for example, by a specific processing unit 290 of the data processing apparatus 12, analyzes the user's instructions using a generation AI, and generates an SQL query. The provision unit is implemented, for example, by the specific processing unit 290 of the data processing apparatus 12, extracts data based on the generated SQL query, and returns the result to the user. The correspondence between each unit and the apparatus or control unit is not limited to the examples described above and various modifications are possible.

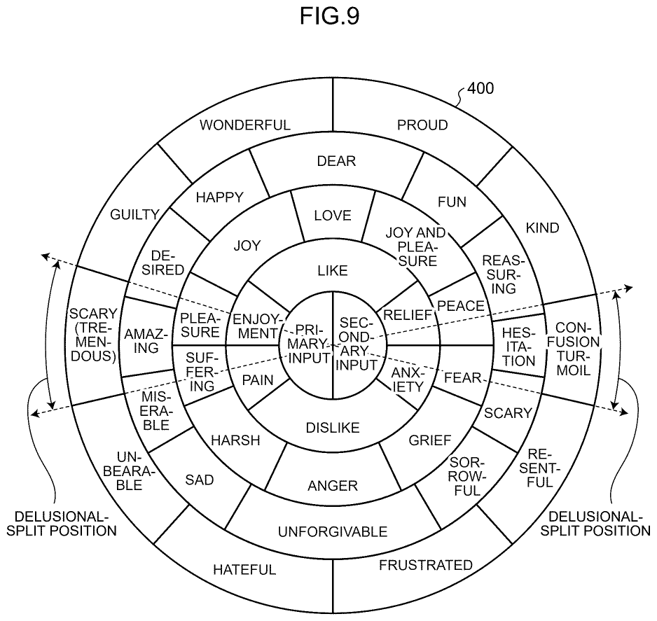

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

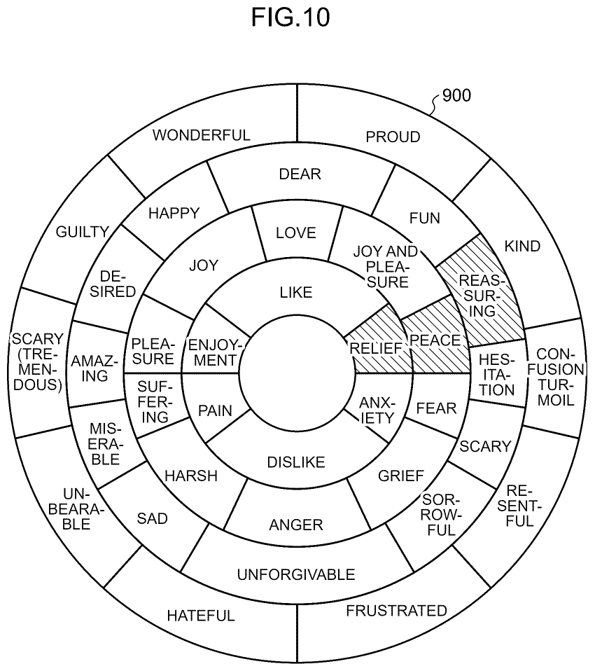

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a reception unit configured to receive instructions from a user; a generation unit configured to analyze the instructions received by the reception unit and generate an SQL query; and a provision unit configured to extract data based on the SQL query generated by the generation unit and return the result.

(Supplementary Note 2) The system according to Supplementary Note 1, wherein the reception unit is configured to receive instructions from the user in a chat format.

(Supplementary Note 3) The system according to Supplementary Note 1, wherein the generation unit is configured to analyze the user's instructions and generate an SQL query.

(Supplementary Note 4) The system according to Supplementary Note 1, wherein the provision unit is configured to extract data based on the generated SQL query and return the result to the user.

(Supplementary Note 5) The system according to Supplementary Note 1, wherein the reception unit is configured to estimate the user's emotion and adjust the timing of receiving instructions based on the estimated emotion.

(Supplementary Note 6)The system according to Supplementary Note 1, wherein the reception unit is configured to analyze the user's past instruction history and select an appropriate reception method.

(Supplementary Note 7) The system according to Supplementary Note 1, wherein the reception unit is configured to perform filtering at the time of receiving instructions based on the user's current project or field of interest.

(Supplementary Note 8) The system according to Supplementary Note 1, wherein the reception unit is configured to estimate the user's emotion and determine the priority of instructions to be received based on the estimated emotion.

(Supplementary Note 9) The system according to Supplementary Note 1, wherein the reception unit is configured to consider the user's geographic location information at the time of receiving instructions and preferentially receive instructions with high relevance.

(Supplementary Note 10) The system according to Supplementary Note 1, wherein the reception unit is configured to analyze the user's social media activity at the time of receiving instructions and receive relevant instructions.

(Supplementary Note 11) The system according to Supplementary Note 1, wherein the generation unit is configured to estimate the user's emotion and adjust the method of generating SQL queries based on the estimated emotion.

(Supplementary Note 12) The system according to Supplementary Note 1, wherein the generation unit is configured to adjust the level of detail of generation based on the importance of the instructions when generating SQL queries.

(Supplementary Note 13) The system according to Supplementary Note 1, wherein the generation unit is configured to apply different generation algorithms according to the category of instructions when generating SQL queries.

(Supplementary Note 14) The system according to Supplementary Note 1, wherein the generation unit is configured to estimate the user's emotion and adjust the length of the SQL query based on the estimated emotion.

(Supplementary Note 15) The system according to Supplementary Note 1, wherein the generation unit is configured to determine the priority of generation based on the submission timing of the instructions when generating SQL queries.

(Supplementary Note 16) The system according to Supplementary Note 1, wherein the generation unit is configured to adjust the order of generation based on the relevance of the instructions when generating SQL queries.

(Supplementary Note 17) The system according to Supplementary Note 1, wherein the provision unit is configured to estimate the user's emotion and adjust the method of providing data based on the estimated emotion.

(Supplementary Note 18) The system according to Supplementary Note 1, wherein the provision unit is configured to analyze the user's past data usage history at the time of providing data and select an appropriate provision method.

(Supplementary Note 19) The system according to Supplementary Note 1, wherein the provision unit is configured to customize the means of provision based on the user's current living situation at the time of providing data.

(Supplementary Note 20) The system according to Supplementary Note 1, wherein the provision unit is configured to estimate the user's emotion and determine the priority of data provision based on the estimated emotion.

(Supplementary Note 21) The system according to Supplementary Note 1, wherein the provision unit is configured to consider the user's geographic location information at the time of providing data and select an appropriate provision method.

(Supplementary Note 22) The system according to Supplementary Note 1, wherein the provision unit is configured to analyze the user's social media activity at the time of providing data and propose means of provision.

What is claimed is:

1. A system comprising:
circuitry configured to:
receive, via a packet-switched network from a client terminal, input data representing a natural language instruction;
apply a Transformer-based neural network model to the input data to perform tokenization, semantic analysis, and entity extraction, and generate a structured query based on the extracted entities;
execute the structured query against a data store to obtain a result set; and
transmit, via the packet-switched network to the client terminal, response data derived from the result set.

2. The system according to claim 1, wherein the circuitry is further configured to receive the input data in a text chat format as a UTF-8 encoded string of up to 4096 tokens.

3. The system according to claim 1, wherein the circuitry is further configured to receive the input data in a voice chat format by converting voice data into text using a speech recognition model comprising an RNN-based or Transformer-based encoder-decoder architecture.

4. The system according to claim 1, wherein the Transformer-based neural network model is configured to tokenize the natural language instruction, generate a syntax tree, extract entities and estimate intent from the tokenized instruction, and map the extracted entities to components of the structured query.

5. The system according to claim 1, wherein the structured query is an SQL query, and wherein the circuitry is further configured to obtain database schema information comprising table names, column names, and data types, and perform a consistency check during generation of the SQL query based on the database schema information.

6. The system according to claim 1, wherein the circuitry is further configured to classify the natural language instruction into one of a plurality of instruction categories using a classification network, and select a category-specific query generation algorithm based on the classified instruction category.

7. The system according to claim 1, wherein the circuitry is further configured to calculate an importance score for the natural language instruction using an importance estimation network, and dynamically adjust a level of detail of the structured query based on the importance score.

8. The system according to claim 7, wherein adjusting the level of detail comprises adjusting at least one of a number of columns in a SELECT clause, a number of conditions in a WHERE clause, a presence of a GROUP BY or ORDER BY clause, a complexity of a JOIN clause, or a setting of a LIMIT clause.

9. The system according to claim 1, wherein the circuitry is further configured to format the result set into at least one of a text format, a table format, or a graph image format based on the natural language instruction and a past conversation history associated with the client terminal.

10. The system according to claim 1, wherein the circuitry is further configured to estimate an emotion of a user associated with the client terminal by applying a multimodal emotion estimation model to at least one of facial image data, audio waveform data, or biometric sensor data, and adjust a timing of receiving the input data based on the estimated emotion.

11. The system according to claim 10, wherein the multimodal emotion estimation model comprises a CNN-based facial expression recognition network for the facial image data, an RNN or Transformer-based speech emotion recognition network for the audio waveform data, and a time-series attention model for the biometric sensor data, and wherein the multimodal emotion estimation model integrates feature vectors from the facial image data, the audio waveform data, and the biometric sensor data to output an emotion label and an emotion score.

12. The system according to claim 10, wherein the circuitry is further configured to adjust a method of generating the structured query based on the estimated emotion, wherein when the emotion indicates a hurry state the circuitry generates a concise structured query extracting a minimum number of columns, and when the emotion indicates a relaxed state the circuitry generates a detailed structured query including aggregation and multi-condition filters.

13. The system according to claim 10, wherein the circuitry is further configured to determine a priority of the natural language instruction based on the estimated emotion, and when the emotion indicates a stress state, postpone processing of low-importance instructions and preferentially process high-importance instructions.

14. The system according to claim 10, wherein the circuitry is further configured to adjust a format of the response data based on the estimated emotion, wherein when the emotion indicates a hurry state the circuitry transmits summary data, and when the emotion indicates a relaxed state the circuitry transmits detailed data including multi-item graphs.

15. The system according to claim 1, wherein the circuitry is further configured to analyze an instruction history associated with the client terminal using a history analysis network comprising an RNN or Transformer-based time-series model, and select a reception method for receiving subsequent input data based on recommendation scores output by the history analysis network.

16. The system according to claim 1, wherein the circuitry is further configured to calculate a relevance score between the natural language instruction and project information or field-of-interest information associated with a user of the client terminal, and filter the natural language instruction based on the relevance score.

17. The system according to claim 1, wherein the circuitry is further configured to obtain geographic location data from the client terminal, calculate a region relevance score between the natural language instruction and the geographic location data, and adjust a processing priority of the natural language instruction based on the region relevance score.

18. A system comprising:
circuitry configured to:
receive, via a packet-switched network from a client terminal, input data representing a natural language instruction as a UTF-8 encoded token sequence;
tokenize the natural language instruction using a Transformer-based large language model comprising an encoder-decoder architecture, generate a syntax tree, and perform entity extraction and intent estimation to identify components for a structured query;
obtain database schema information comprising table names, column names, and data types, perform a consistency check of the structured query against the database schema information, and apply error correction rules comprising SQL injection prevention and automatic escaping of reserved words;
execute the structured query against a relational database or a NoSQL database to obtain a result set comprising matrix-form data; and
format the result set into at least one of a text format, a table format, or a graph image format based on the natural language instruction and a past conversation history, and transmit, via the packet-switched network to the client terminal, response data comprising the formatted result set.

19. The system according to claim 18, wherein the Transformer-based large language model is trained using supervised learning with paired datasets of natural language sentences and corresponding structured queries, transfer learning, and fine-tuning, with a loss function comprising cross-entropy loss and a syntax error rate minimization metric.

20. A method performed by circuitry of a system, the method comprising:
receiving, via a packet-switched network from a client terminal, input data representing a natural language instruction;
applying a Transformer-based neural network model to the input data to perform tokenization, semantic analysis, and entity extraction, and generating a structured query based on the extracted entities;
executing the structured query against a data store to obtain a result set; and
transmitting, via the packet-switched network to the client terminal, response data derived from the result set.
